(19) United States
(12) Patent Application Publication
(10) Pub. No.: US 2025/0104315 A1
(43) Pub. Date: Mar. 27, 2025

(54) INFORMATION PROCESSING APPARATUS, METHOD, AND NON-TRANSITORY COMPUTER-READABLE STORAGE MEDIUM STORING PROGRAM

(71) Applicant: CANON KABUSHIKI KAISHA, Tokyo (JP)

(72) Inventors: TAKAYUKI YAMADA, Kanagawa (JP); SHINJIRO HORI, Kanagawa (JP); KOUTA MURASAWA, Kanagawa (JP); KAZUYA OGASAWARA, Kanagawa (JP); KAZUFUMI KONDO, Kanagawa (JP)

(21) Appl. No.: 18/895,493

(22) Filed: Sep. 25, 2024

(30) Foreign Application Priority Data
Sep. 26, 2023 (JP) 2023-163581

(51) Int. Cl. G06T 11/60; G06V 30/418

(52) U.S. Cl. CPC G06T 11/60; G06V 30/418; G06T 2200/24; G06V 2201/09

(57) ABSTRACT

The first commercial material data and the second commercial material data to be displayed are commercial material data of a combination in which a similarity of content is highest, and a similarity of the brand design is highest among a plurality of combinations obtained from the plurality of generated commercial material data and the plurality of generated commercial material data.

### BACKGROUND OF THE INVENTION

### Field of the Invention

The present invention relates to an information processing apparatus, a method, and a non-transitory computer-readable storage medium storing a program.

### Description of the Related Art

There is conventionally known preparing a template that stores information such as the shape and arrangement of images, characters, and graphics constituting a poster and automatically arranging images, characters, and graphics in accordance with the template, thereby generating a poster. Japanese Patent Laid-Open No. 2017-59123 proposes generating a poster by selecting a template in ascending order of the difference between the impression evaluation value of a template and the impression evaluation value of an image.

### SUMMARY OF THE INVENTION

In Japanese Patent Laid-Open No. 2017-59123, generating a commercial material that gives an impression intended by a user is not taken into consideration at all. Furthermore, if different images are used not only in one type of commercial material but also between a plurality of types of commercial materials, generating the plurality of commercial materials recognizable as a unified design is not taken into consideration at all.

The present invention provides an information processing apparatus for generating and displaying a plurality of commercial materials that give a sense of unity and give the impression of a brand intended by a user, a method, and a non-transitory computer-readable storage medium storing a program.

The present invention in one aspect provides an information processing apparatus comprising: at least one processor and at least a memory coupled to the at least one processor and having instructions stored thereon, and when executed by the at least one processor, acting as: a first acceptance unit configured to accept content of a commercial material; a second acceptance unit configured to accept a brand design; a third acceptance unit configured to accept a designation of an impression that the commercial material gives to a user; a fourth acceptance unit configured to accept a condition of the commercial material; a first generation unit configured to generate a plurality of commercial material data corresponding to a first commercial material type based on the content accepted by the first acceptance unit, the brand design accepted by the second acceptance unit, the designation of the impression accepted by the third acceptance unit, and the condition of the commercial material accepted by the fourth acceptance unit; a second generation unit configured to generate a plurality of commercial material data corresponding to a second commercial material type based on the content accepted by the first acceptance unit, the brand design accepted by the second acceptance unit, the designation of the impression accepted by the third acceptance unit, and the condition of the commercial material accepted by the fourth acceptance unit; and a display unit configured to display a commercial material image based on first commercial material data included in the plurality of commercial material data generated by the first generation unit and second commercial material data included in the plurality of commercial material data generated by the second generation unit, wherein the first commercial material data and the second commercial material data displayed by the display unit are commercial material data of a combination in which a similarity of content is highest, and a similarity of the brand design is highest among a plurality of combinations obtained from the plurality of commercial material data generated by the first generation unit and the plurality of commercial material data generated by the second generation unit.

According to the present invention, it is possible to generate and display a plurality of commercial materials that give a sense of unity and give the impression of a brand intended by a user.

Further features of the present invention will become apparent from the following description of exemplary embodiments with reference to the attached drawings.

### BRIEF DESCRIPTION OF THE DRAWINGS

FIG. 1 is a block diagram showing the hardware configuration of a multiple commercial material generation apparatus;

FIG. 2 is a software block diagram of a multiple commercial material creation application;

FIGS. 3A and 3B are views showing a skeleton;

FIG. 4 is a view showing a table of coloring patterns;

FIG. 5 is a view showing an application activation screen;

FIG. 6 is a view showing a multiple commercial material preview screen;

FIG. 7 is a flowchart showing impression quantification processing;

FIG. 8 is a view for explaining a subjective evaluation method for an impression;

FIGS. 9A to 9D are flowcharts showing multiple commercial material generation processing;

FIGS. 10A to 10C are views for explaining selection of a skeleton;

FIGS. 11A and 11B are views showing a coloring pattern impression table;

FIG. 12 is a software block diagram of a layout unit;

FIG. 13 is a flowchart showing the process of S911;

FIGS. 14A to 14C are views for explaining information input to the layout unit;

FIGS. 15A to 15D are views for explaining the process of processing of the layout unit;

FIG. 16 is a view showing a UI configured to set a target impression and set brand information;

FIG. 17 is a software block diagram of a multiple commercial material creation application;

FIG. 18 is a flowchart showing multiple commercial material generation processing;

FIGS. 19A to 19F are views for explaining tables used by a combination generation unit;

FIGS. 20A and 20B are views for explaining the operation of S1802 from the second loop;

FIGS. 21A to 21E are views for explaining subjective evaluation for deciding a weight between design elements;

FIG. 22 is a view for explaining subjective evaluation for deciding a weight between design elements;

FIG. 23 is a view showing an application activation screen;

FIG. 24 is a flowchart when a “reflect stored commercial material” button is pressed;

FIG. 25 is a view showing an application activation screen;

FIG. 26 is a view showing a multiple commercial material preview screen;

FIGS. 27A and 27B are flowcharts showing multiple commercial material generation processing;

FIG. 28 is a view showing combinations of commercial material sets;

FIG. 29 is a view showing a table in which a target impression and an image feature amount are associated;

FIG. 30 is a view showing gamma curves used when performing gamma correction; and

FIG. 31 is a view showing an RGB magnification when performing color temperature correction.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

In this embodiment, “commercial material” means a printed product such as a poster, a pamphlet, a menu in a store, or a postcard, and indicates, for example, the design of an advertisement medium to users. In this embodiment, “brand” expresses, by a design, the identity of a company or a store (a corporate philosophy or vision, a guideline for actions, and characteristics). To make users widely recognize a brand, it is necessary to give a message to the users by a design having a consistent worldview. The key to brand recognition is a design giving a sense of unity and a consistent worldview. To do this, product packages, store designs, and commercial materials (web sites, pamphlets, posters, business cards, and postcards) for public relations, which are points of contact with the users, need to have a design that gives a sense of unity. To make the design that gives a sense of unity, a plurality of commercial materials need to include similar design elements. Examples of the design element are a logo (symbol mark), a font, a pattern, and a color. If the plurality of commercial materials can include the design elements, the unity of the design can be felt, and the users can recognize the consistent worldview. In this embodiment, it is possible to automatically generate, for a plurality of commercial materials, a design that gives a sense of unity and gives the impression of a brand intended by a user. This allows a user who does not have knowledge of design to generate a plurality of commercial materials for making a brand recognizable.

In this embodiment, processing of, in a multiple commercial material generation apparatus, operating a multiple commercial material creation application configured to create a plurality of commercial materials to automatically generate a plurality of commercial materials will be described as an example. Note that in the following explanation, “image” includes a still image and a frame image extracted from a moving image, unless it is specifically stated otherwise.

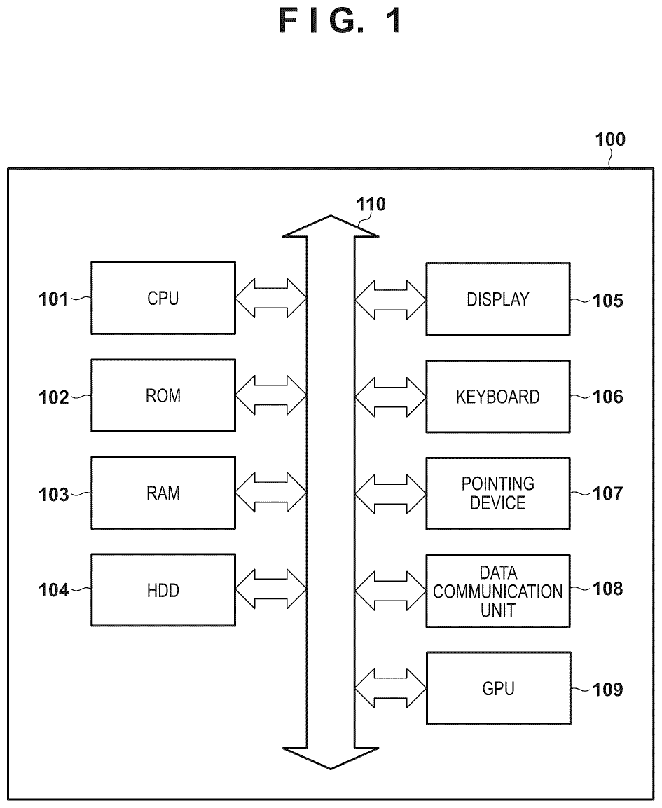

FIG. 1 is a block diagram showing the hardware configuration of a multiple commercial material generation apparatus 100. Note that the multiple commercial material generation apparatus 100 is an information processing apparatus, and examples are a personal computer (to be referred to as a PC hereinafter) and a smartphone. In this embodiment, a description will be made assuming that the multiple commercial material generation apparatus is a PC. The multiple commercial material generation apparatus 100 includes a CPU 101, a ROM 102, a RAM 103, an HDD 104, a display 105, a keyboard 106, a pointing device 107, a data communication unit 108, and a GPU 109.

The CPU (central processing unit/processor) 101 generally controls the multiple commercial material generation apparatus 100 and, for example, reads out a program stored in the ROM 102 to the RAM 103 and executes it, thereby implementing an operation according to this embodiment. FIG. 1 shows one CPU, but a plurality of CPUs may be provided. The ROM 102 is a general-purpose ROM and stores, for example, programs to be executed by the CPU 101. The RAM 103 is a general-purpose RAM and is used as a working memory for temporarily storing various kinds of information, for example, at the time of execution of the programs by the CPU 101. The HDD (hard disk) 104 is a storage medium (storage unit) configured to store databases that hold image files and processing results of image analysis and the like, and skeletons used by a multiple commercial material creation application. The skeleton will be described later.

The display 105 is a display unit that displays, to a user, a user interface (UI) according to this embodiment and a plurality of electronic commercial materials as a layout result of image data (to be also referred to as “images” hereinafter). The keyboard 106 and the pointing device 107 accept instruction operations from the user. The display 105 may have a touch sensor function. The keyboard 106 is used by the user to, for example, input generation conditions of a plurality of commercial materials to be created on the user interface (UI) displayed on the display 105. The pointing device 107 is used by the user to, for example, click a button on the UI displayed on the display 105.

The data communication unit 108 performs communication with an external apparatus via a wired or wireless network. The data communication unit 108, for example, transmits data laid out by an automatic layout function to a printer or a server capable of communicating with the multiple commercial material generation apparatus 100. The GPU 109 is a Graphics Processing Unit and can perform an efficient operation by parallelly processing more data. The GPU 109 is used when, for example, performing learning a plurality of times using a learning model such as deep learning. A data bus 110 connects the blocks shown in FIG. 1 so that they are able to communicate with each other.

Note that the configuration shown in FIG. 1 is merely an example, and the configuration is not limited to this. For example, the multiple commercial material generation apparatus 100 may display a UI on an external display.

The multiple commercial material creation application according to this embodiment is stored in the HDD 104. The multiple commercial material creation application is activated by the user executing an operation of clicking or double-clicking, using the pointing device 107, the icon of the application displayed on the display 105.

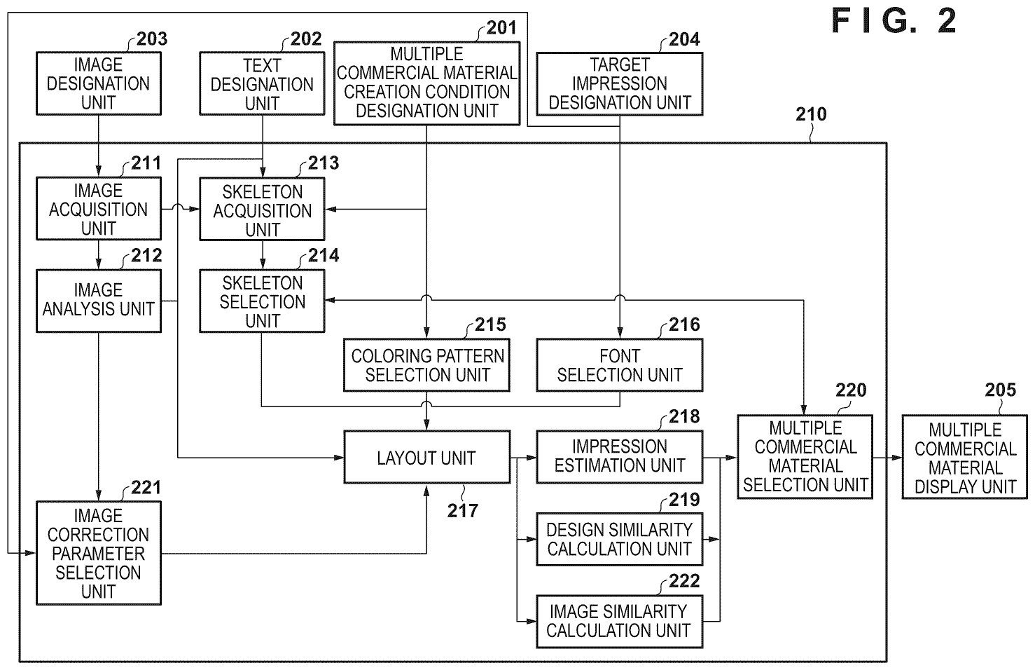

FIG. 2 is a software block diagram of a multiple commercial material creation application. The multiple commercial material creation application includes a multiple commercial material creation condition designation unit 201, a text designation unit 202, an image designation unit 203, a target impression designation unit 204, a multiple commercial material display unit 205, and a multiple commercial material generation unit 210. Furthermore, the multiple commercial material generation unit 210 includes an image acquisition unit 211, an image analysis unit 212, a skeleton acquisition unit 213, a skeleton selection unit 214, a coloring pattern selection unit 215, a font selection unit 216, an image correction parameter selection unit 221, a layout unit 217, an impression estimation unit 218, a design similarity calculation unit 219, an image similarity calculation unit 222, and a multiple commercial material selection unit 220.

When the multiple commercial material creation application is installed in the multiple commercial material generation apparatus 100, an activation icon is displayed on the top screen (desktop) of an operating system (OS) operating on the multiple commercial material generation apparatus 100. The user operates (for example, double-clicks) the activation icon displayed on the display 105 using the pointing device 107. If this operation is performed, the program of the multiple commercial material creation application stored in the HDD 104 is loaded into the RAM 103 and executed by the CPU 101. The multiple commercial material creation application is thus activated.

Program modules corresponding to the constituent elements shown in FIG. 2 are included in the above-described multiple commercial material creation application. When the CPU 101 executes the program modules, the CPU 101 functions as the constituent elements shown in FIG. 2. The constituent elements shown in FIG. 2 will be described below assuming that these execute various kinds of processing. Also, FIG. 2 shows a software block diagram particularly associated with the multiple commercial material generation unit 210 that executes an automatic multiple commercial material creation function.

In accordance with a UI operation using the pointing device 107, the multiple commercial material creation condition designation unit 201 designates multiple commercial material creation conditions in the multiple commercial material generation unit 210. In this embodiment, as the multiple commercial material creation conditions, the types and the application purpose categories of a plurality of commercial materials to be created are designated. The sizes of the plurality of commercial materials are linked with the types of plurality of commercial materials. Depending on the commercial material, there may be a plurality of types of sizes. In this case, the actual values of a width and a height may be designated, or a paper size such as A1 or A2 may be designated. The application purpose category is a category indicating for what kind of application purpose the plurality of commercial materials are to be used, and examples are restaurant, school event, and sale.

By a UI operation using the keyboard 106, the text designation unit 202 designates character information to be arranged on a commercial material to be generated. Character information to be arranged indicates a character string indicating, for example, a title, a date/time, a location, or the like. Types of character information may be changed depending on the type of a commercial material to be created, which is selected by the multiple commercial material creation condition designation unit 201. For example, if a poster is selected, a title, a subtitle, and a text are designated. If a postcard is selected, a title, an address, and a contact are displayed. If a plurality of commercial materials are selected, pieces of repetitive information may be designated independently or may be put in one. Also, the text designation unit 202 links each character information with the title, the date/time, or the location such that the type of information can be discriminated, and then outputs the character information to the skeleton acquisition unit 213 and the layout unit 217.

The image designation unit 203 designates one or a plurality of image data that are stored in the HDD 104 and are to be arranged on a plurality of commercial materials. The images to be designated may individually be designated depending on the type of a commercial material to be created, which is selected by the multiple commercial material creation condition designation unit 201, or common images may be designated. The image data may be designated, for example, based on the structure of a file system including image data, such as a device and a directory, or may be designated based on additional information such as an image capturing date/time for identifying an image or attribute information. The image designation unit 203 outputs the file path of the designated image to the image acquisition unit 211.

The target impression designation unit 204 designates one target impression for a plurality of commercial materials to be created. The target impression is an impression the plurality of commercial materials to be created are requested to finally evoke. In this embodiment, an intensity representing the degree of impression to be imparted to a word representing the impression is designated by a UI operation using the pointing device 107. Information indicating the target impression designated by the target impression designation unit 204 is shared by the skeleton selection unit 214, the coloring pattern selection unit 215, the font selection unit 216, the image correction parameter selection unit 221, and the multiple commercial material selection unit 220. Details of the impression will be described later.

The configuration of the multiple commercial material generation unit 210 will be described next in detail. A different commercial material can be implemented by the skeleton acquisition unit 213 selecting a skeleton of a target commercial material.

The image acquisition unit 211 acquires image data designated by the image designation unit 203 from the HDD 104. The image acquisition unit 211 outputs the acquired image data to the image analysis unit 212 and the layout unit 217. In addition, the image acquisition unit 211 outputs the number of acquired images to the skeleton acquisition unit 213. Examples of an image stored in the HDD 104 are a still image and a frame image cut out from a moving image. The still image and the frame image are acquired from an image capturing device such as a digital camera or a smart device. The image capturing device may be provided in the multiple commercial material generation apparatus 100, or may be provided in an external apparatus. Note that if the image capturing device is an external apparatus, the image is acquired via the data communication unit 108. Also, as another example, the still image may be an illustration image created by image editing software or a CG image created by Computer Graphics (CG) generation software. The still image and the cutout image may be images acquired from a network or a server via the data communication unit 108. An example of the image acquired from the network or the server is a social networking service image (to be referred to as an “SNS image” hereinafter). Also, the program executed by the CPU 101 analyzes, for each image, data added to the image and determines the storage source. For example, as for an SNS image, the acquisition destination may be managed in an application by acquiring the image from the SNS via the application. Note that the image is not limited to the above-described images, and may be another type of image.

The image analysis unit 212 executes image data analysis processing using a method to be described later for the image data acquired from the image acquisition unit 211, thereby acquiring information indicating an image feature amount to be described later. More specifically, for example, the image analysis unit 212 executes object recognition processing to be described later and acquires information indicating the image feature amount of image data. Also, the image analysis unit 212 links the acquired information indicating the image feature amount with the image data and outputs it to the layout unit 217.

The skeleton acquisition unit 213 acquires, from the HDD 104, one or a plurality of skeletons that match the conditions designated by the multiple commercial material creation condition designation unit 201, the text designation unit 202, and the image acquisition unit 211. In this embodiment, a skeleton is information indicating the arrangement of character strings, images, and graphics to be arranged on a plurality of commercial materials. In this embodiment, the skeleton is one of commercial material constituent elements that constitute a commercial material together with a coloring pattern and a font.

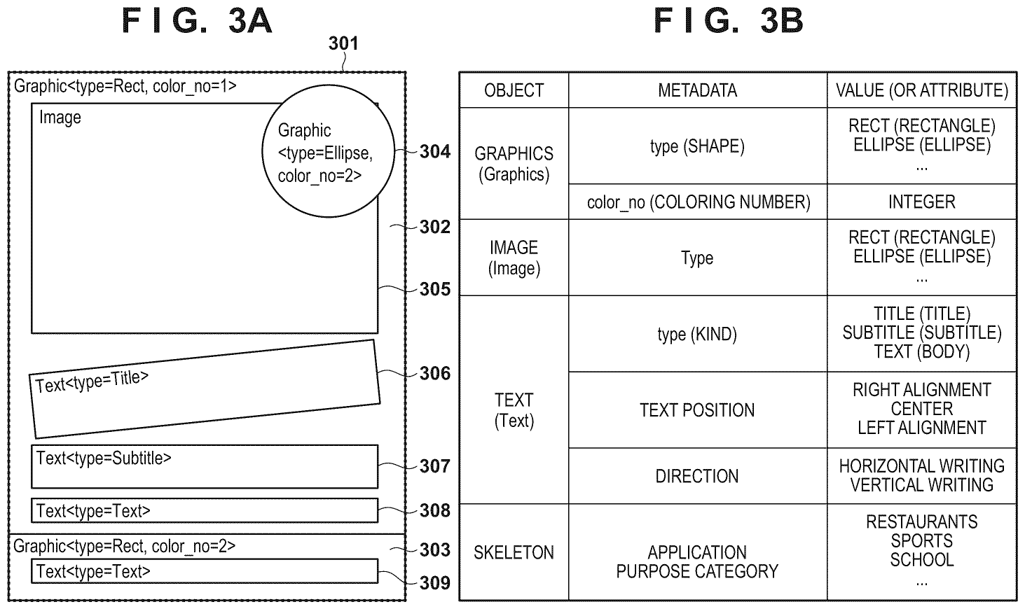

FIGS. 3A and 3B are views showing an example of a skeleton for a poster among commercial materials. On a skeleton 301 shown in FIG. 3A, three graphic objects 302, 303, and 304, one image object 305, and four character objects 306, 307, 308, and 309 that are objects to arrange characters are arranged. In each object, not only a position indicating a location to arrange the object, a size, and an angle but also metadata necessary for generating a poster are recorded. FIG. 3B is a view showing an example of metadata. For example, each of the character objects 306 to 309 holds, as the attribute of metadata, what kind of character information is to be arranged. Here, it is indicated that a title is arranged in the character object 306, a subtitle is arranged in the character object 307, and a text is arranged in each of the character objects 308 and 309. In addition, each of the graphic objects 302 to 304 holds the shape of a graphic and a coloring number (coloring ID) indicating a coloring pattern as the attribute of metadata. Here, it is indicated that the attribute of each of the graphic objects 302 and 303 is rectangle, and the attribute of the graphic object 304 is ellipse. Assume that coloring number 1 is assigned to the graphic object 302, and coloring number 2 is assigned to the graphic objects 303 and 304. Here, the coloring number is information to be referred to in coloring to be described later, and a different coloring number indicates that a different color is assigned. A graphic object may be painted and drawn in a uniform color. Also, a graphic object may cut out a pattern of a background illustration into the shape of the graphic object and draw it. Note that the types of objects and metadata are not limited to these. For example, there may be a map object used to arrange a map or a barcode object used to arrange a QR Code® or a barcode. Also, as the metadata of a character object, there may be metadata indicating the width between rows or the width between characters. The metadata may include the application purpose of the skeleton and may be used to control whether the skeleton is usable in accordance with the application purpose.

Skeletons may be managed divisionally for each of a plurality of commercial materials. For example, there are skeletons for a plurality of commercial materials, skeletons for a menu, skeletons for a postcard, skeletons for a three-fold leaflet, skeletons for a calendar, skeletons for a banner, and the like. The skeletons may be managed as a group between a plurality of commercial materials based on the association of an arrangement or the like. For example, skeletons of group 1 form a skeleton group in which a premium nature can be felt, and the same skeleton group ID is held in the metadata of the skeletons. Accordingly, based on a skeleton used to create one commercial material, a skeleton to be applied to another commercial material can be decided. As a result, even if the design of a plurality of commercial materials are created, a unified design between the plurality of commercial materials can be generated.

Skeletons may be managed divisionally depending on the width-to-height ratio. This makes it possible to acquire a skeleton of a width-to-height ratio that matches a size designated by the multiple commercial material creation condition designation unit 201. The skeletons may be stored in the HDD 104 using, for example, a CSV format, or may be stored using a DB format such as SQL. The skeleton acquisition unit 213 outputs the one or the plurality of skeletons acquired from the HDD 104 to the skeleton selection unit 214.

Among the skeletons acquired from the skeleton acquisition unit 213, the skeleton selection unit 214 selects a skeleton that matches the type of a commercial material designated by the multiple commercial material creation condition designation unit 201 and matches the target impression designated by the target impression designation unit 204. The skeleton selection unit 214 then outputs the skeleton to the layout unit 217. One or a plurality of skeletons are selected in correspondence with one type of commercial material, and one or a plurality of skeletons matching the target impression are selected for each commercial material type. Since the whole arrangement on the commercial material is decided by the skeleton, variations of the commercial material after generation can be increased by preparing various types of skeletons in advance.

The coloring pattern selection unit 215 acquires, from the HDD 104, one or a plurality of coloring patterns matching the target impression designated by the target impression designation unit 204, and outputs these to the layout unit 217. The coloring pattern is a combination of colors to be used in a commercial material. Also, if a color is designated by the multiple commercial material creation condition designation unit 201, a coloring pattern including the color is also acquired from the HDD 104 and output to the layout unit 217.

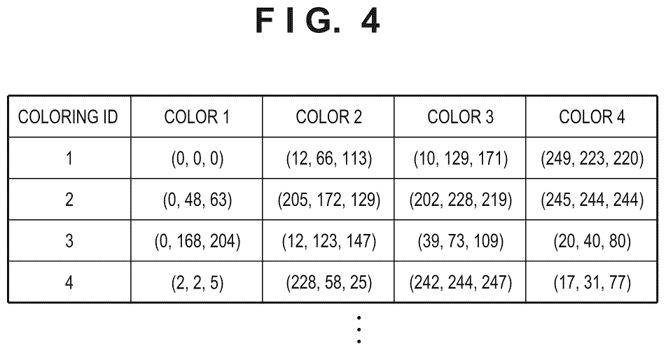

FIG. 4 is a view showing an example of a table of coloring patterns. In this embodiment, the coloring pattern is represented as a combination of four colors. The column of coloring IDs in FIG. 4 show IDs each used to uniquely specify a coloring pattern. The columns of colors 1 to 4 show colors each represented by RGB values of 0 to 255 arranged in this order ((R, G, B)=(0 to 255, 0 to 255, 0 to 255)). Note that in this embodiment, coloring patterns each formed by a combination of four colors are used, but the number of colors may be changed, or a plurality of numbers of colors may coexist.

The font selection unit 216 acquires, from the HDD 104, one or a plurality of font patterns matching the target impression designated by the target impression designation unit 204, and outputs these to the layout unit 217. The font pattern is a combination of at least one of the font of a title, the font of a subtitle, and the font of a text. Also, if a font is designated by the multiple commercial material creation condition designation unit 201, a font pattern including the font is also acquired from the HDD 104 and output to the layout unit 217.

The image correction parameter selection unit 221 selects one or a plurality of image correction parameters in accordance with the image feature amount acquired by the image analysis unit 212 and the target impression designated by the target impression designation unit 204. The image correction parameter selection unit 221 links the selected image correction parameter with the image data and outputs it to the layout unit 217.

The layout unit 217 lays out various kinds of data on each of the one or the plurality of skeletons acquired from the skeleton selection unit 214, thereby creating one or a plurality of commercial material data more than the number of types designated by the multiple commercial material creation condition designation unit 201. The layout unit 217 arranges, on each skeleton, the text acquired from the text designation unit 202. Also, the layout unit 217 performs image correction for the image data acquired from the image correction parameter selection unit 221 and then arranges it on the skeleton. The layout unit 217 applies the coloring pattern acquired from the coloring pattern selection unit 215, and applies the font pattern acquired from the font selection unit. If a pattern is designated by the multiple commercial material creation condition designation unit 201, the layout unit 217 arranges the pattern on each skeleton. If a logo is designated by the multiple commercial material creation condition designation unit 201, the layout unit 217 arranges the logo on each skeleton. The layout unit 217 outputs the one or the plurality of generated commercial material data to the impression estimation unit 218, the design similarity calculation unit 219, and the image similarity calculation unit 222.

The impression estimation unit 218 estimates the impression of each commercial material data among the plurality of commercial material data acquired from the layout unit 217, and links the estimated impression with the commercial material data. The impression estimation unit 218 outputs the one or the plurality of commercial material data each linked with the estimated impression to the multiple commercial material selection unit 220.

The design similarity calculation unit 219 calculates the design similarity between different commercial materials among the plurality of commercial material data acquired from the layout unit 217, and links the calculated design similarity with the commercial material data. The design similarity calculation unit 219 outputs the one or the plurality of commercial material data each linked with the design similarity to the multiple commercial material selection unit 220.

The image similarity calculation unit 222 calculates the similarity between image data arranged on different commercial materials among the plurality of commercial material data acquired from the layout unit 217, and links the calculated image similarity with the commercial material data. The image similarity calculation unit 222 outputs the one or the plurality of commercial material data each linked with the image similarity to the multiple commercial material selection unit 220.

The multiple commercial material selection unit 220 calculates an impression matching level by comparing the target impression designated by the target impression designation unit 204 and the estimated impression of each commercial material data linked with the estimated impression acquired from the impression estimation unit 218. The multiple commercial material selection unit 220 decides a combination of commercial materials based on the impression matching level, the design similarity between different commercial materials acquired by the design similarity calculation unit 219, and the image similarity between different commercial materials acquired by the image similarity calculation unit 222. Which one of the impression matching level, the design similarity, and the image similarity should be given importance in deciding the combination changes depending on a reflection level of brand information designated by the multiple commercial material creation condition designation unit 201. The decided combination of commercial materials is stored in the HDD 104. The multiple commercial material selection unit 220 outputs each selected commercial material data to the multiple commercial material display unit 205.

The multiple commercial material display unit 205 outputs a multiple commercial material image to be displayed on the display 105 in accordance with the combination of commercial material data acquired from the multiple commercial material selection unit 220. The multiple commercial material image is, for example, bitmap data. The multiple commercial material display unit 205 displays the multiple commercial material image on the display 105.

Note that a function of, after the generation result is displayed on the multiple commercial material display unit 205, editing the arrangement, colors, and shapes, and the like of the images, texts, and graphics by an additional operation of the user to change the design to a design demanded by the user may be imparted to the multiple commercial material creation application. Also, if a function of printing multiple commercial material data stored in the HDD 104 by a printer according to conditions designated by the multiple commercial material creation condition designation unit 201 is provided, the user can obtain the printed products of the plurality of created commercial materials.

### <Example of Display Screen>

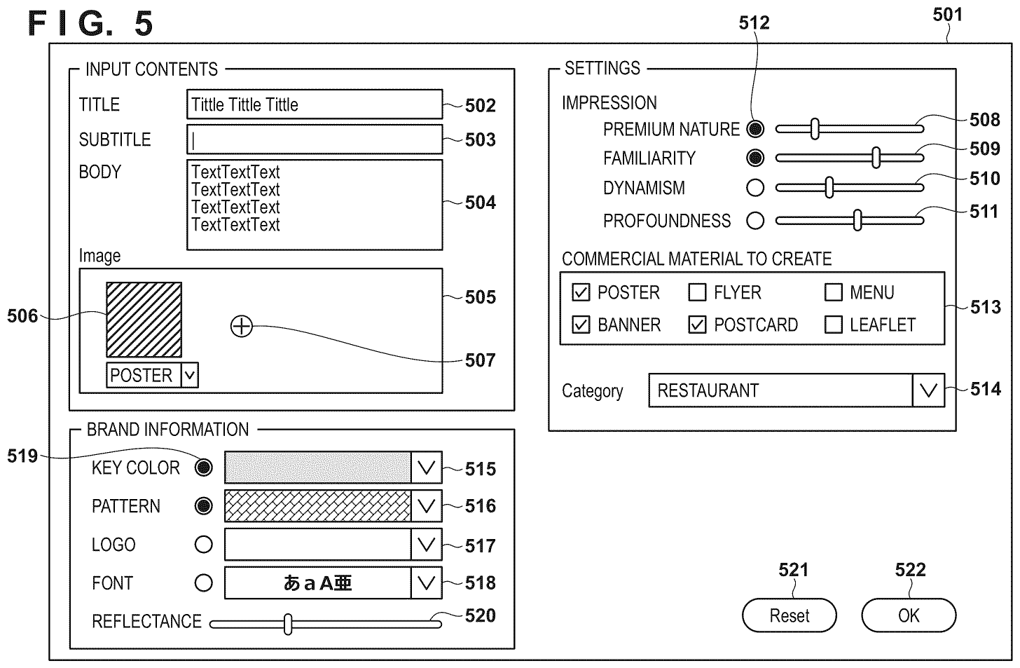

FIG. 5 is a view showing an example of an application activation screen 501 provided by the multiple commercial material creation application. The application activation screen 501 is a setting screen displayed on the display 105. The user sets multiple commercial material creation conditions to be described later, texts, and images via the application activation screen 501, and the multiple commercial material creation condition designation unit 201, the image designation unit 203, and the text designation unit 202 acquire the set contents from the user via the UI screen.

A title box 502, a subtitle box 503, and a text box 504 each accept a designation of character information to be arranged on a plurality of commercial materials. Note that in this embodiment, three types of character information are accepted as an example, but the present invention is not limited to this. For example, character information of a location, a date/time, or the like may additionally be accepted. In addition, not all designations need be done, and some boxes may be blank. In addition, the display may be changed in accordance with the designation result of a creation commercial material designation region 513 to be described later. For example, if “poster” is selected, boxes for designating a title, a subtitle, and a text are displayed. In a case of “postcard”, boxes for designating a title, an address, and a contact are displayed. If a plurality of commercial materials are selected, repetitive boxes may be designated independently or may be put in one.

An image designation region 505 is a region in which an image to be arranged on the plurality of commercial materials is displayed. An image 506 indicates the thumbnail of a designated image, and a commercial material that uses the image is selected. An image addition button 507 is a button configured to add an image to be arranged. If the user presses the image addition button 507, the image designation unit 203 displays a dialog screen used to select a file stored in the HDD 104, and accepts image file selection by the user. The thumbnail of the selected image is then added to the image designation region 505. Note that in this embodiment, as an example, the user can designate a commercial material to be used by the image 506, but it is not always necessary to designate the commercial material that uses the image. In this case, for example, the layout unit 217 may select the image to be arranged on the skeleton.

Impression sliders (impression slider bars or impression setting sliders) 508 to 511 are objects that set the factors of one target impression for each commercial material to be created. For example, the slider 508 is a slider that sets the factor of a target impression concerning a premium nature. If the slider 508 is moved to the right side, the premium nature is set high. If the slider 508 is moved to the left side, a target impression is set such that the commercial material has a low premium nature (gives a cheap impression). Also, when the factors of target impressions set by the sliders are combined, a target impression is set on which not only the factor of target impression set by one slider but also the factors of target impressions set by other sliders are reflected. For example, assume a case where a user operation is performed on the screen of the multiple commercial material creation application to set the impression slider 508 to the right side of the center of the slider and set the impression slider 511 to the left side of the center of the slider. In this case, a commercial material having a refined impression with a high premium nature and a low profoundness is generated. In addition, for example, if the impression slider 508 is set to the right side of the center of the slider, and the impression slider 511 is set to the right side of the center of the slider, a commercial material having a gorgeous impression in which both the premium nature and the profoundness are high is generated. As described above, when the factors of target impressions indicated by the plurality of impression sliders are combined, even if a factor of a common target impression “high premium nature” is set, target impressions of different directions, that is, a “refined” target impression and a “gorgeous” target impression can be set. That is, the target impression can be formed and decided by a plurality of factors representing impressions but may be decided by one factor representing an impression. In this embodiment, defining a state in which a slider is set at the leftmost position as “−2” and a state in which a slider is set at the rightmost position as “+2”, the value is corrected to an integer value of −2 to +2. As for these numerical values indicating impressions, “−2” indicates “low”, “−1” indicates “somewhat low”, “0” indicates “neither”, “+1” indicates “somewhat high”, and “+2” indicates “high”. Note that the purpose for correcting to −2 to +2 is to facilitate a distance calculation to be described later by making the scale match the estimated impression. However, the present invention is not limited to this, and normalization may be done using values 0 to 1.

An impression enable radio button 512 is a button capable of executing control of enabling or disabling the setting of each target impression. The user can set whether to enable or disable the setting of each target impression by pressing the impression enable radio button 512 to set on/off. For example, if off is selected by the impression enable radio button 512, the impression is excluded from control of impression. For example, if the user wants to create a restrained commercial material with a low dynamism but has no particular designations concerning other impressions, a commercial material specialized to the low dynamism can be generated by turning off the impression enable radio buttons 512 other than that for the dynamism. Note that FIG. 5 shows a state in which on is selected for the premium nature and the familiarity, and off is selected for the dynamism and the profoundness. This makes it possible to flexibly control whether to use all target impressions for commercial material generation or use only some target impressions for commercial material generation. Note that the impression enable radio buttons 512 may be omitted if each target impression can be disabled by setting a corresponding slider at the leftmost position (for example, if the slider 508 is set at the leftmost position, the premium nature is set to 0). In this case, when disabling the setting of each target impression, the user can disable the setting of each target impression by setting the slider at the leftmost position.

The creation commercial material designation region 513 is formed by a plurality of checkboxes that decide the types of commercial materials to be created. The checkbox of a commercial material to be created can be enabled or disabled by the click operation of the pointing device 107 from the user. A category list box 514 can set application purpose categories of a plurality of commercial materials to be created.

In this embodiment, brand information (brand design) can be input on the UI screen in addition to the above-described conditions. By inputting brand information, the user can designate use of the same design element even between different commercial materials. This can improve the sense of unity given by the design between different commercial materials. Boxes capable of setting a key color, a pattern, a logo, and a font as examples of design elements will be described below. This is merely an example, and there may be other items concerning the design.

Information of a color common to different commercial materials is input to a key color designation box 515. In this embodiment, it is possible to display a list for designating a color and designate a color by the click operation of the pointing device 107. Also, by the click operation of the pointing device 107, a UI (not shown) configured to designate a color may further be displayed to designate a color. For example, a UI configured to display a color palette with a plurality of colors arranged and select a color may be used.

Information of a pattern common to different commercial materials is input to a pattern designation box 516. In this embodiment, it is possible to display a list for designating a pattern and designate a pattern by the click operation of the pointing device 107. Also, a file storing a pattern may be selected to designate the pattern by the click operation of the pointing device 107. The file may be an image file (JPEG or bitmap), or may be vector data (PDF).

Information of a logo common to different commercial materials is input to a logo designating box 517. In this embodiment, it is possible to display a list for designating a logo and designate a logo by the click operation of the pointing device 107. Also, a file storing a logo may be selected to designate the logo by the click operation of the pointing device 107. The file may be an image file (JPEG or bitmap), or may be vector data (PDF).

Information of a font common to different commercial materials is input to a font designation box 518. In this embodiment, it is possible to display a list for designating a font and designate a font by the click operation of the pointing device 107. Also, a file storing a font may be selected to designate the font by the click operation of the pointing device 107.

A reflection level slider bar 520 sets a weight indicating how much the brand information set above should be reflected as a design similarity. At the leftmost position, the weight is 0, and setting is done to neglect input brand information. At the rightmost position, the weight is 1, and input brand information is always used. For example, if the reflection level is designated as shown in FIG. 5, the reflection level is 0.4. In the above-described multiple commercial material selection unit 220, the weight by the design similarity is 0.4, and the weight by the impression value is 0.6. A brand information enable radio button 519 is a button capable of executing control of enabling or disabling the setting of each brand information. The user can set whether to enable or disable the setting of each brand information by pressing the brand information enable radio button 519 to set on/off. FIG. 5 shows a state in which the key color and the pattern are enabled.

A reset button 521 is a button used to reset the setting information on the application activation screen 501. If the user presses an OK button 522, the multiple commercial material creation condition designation unit 201, the text designation unit 202, the image designation unit 203, and the target impression designation unit 204 output the contents set on the application activation screen 501 to the multiple commercial material generation unit 210. At this time, the multiple commercial material creation condition designation unit 201 acquires the types of commercial materials to be created from the creation commercial material designation region 513, and the application purpose categories of the plurality of commercial materials to be created from the category list box 514. Also, the multiple commercial material creation condition designation unit 201 acquires the color from the key color designation box 515, the pattern from the pattern designation box 516, the logo from the logo designating box 517, and the font from the font designation box 518. Furthermore, the multiple commercial material creation condition designation unit 201 acquires the reflection level of the brand information from the reflection level slider bar 520, and whether the brand information is enabled or not from the brand information enable radio button 519.

The text designation unit 202 acquires character information to be arranged on the plurality of commercial materials from the title box 502, the subtitle box 503, and the text box 504. The image designation unit 203 acquires the path of an image file to be arranged on the plurality of commercial materials from the image designation region 505. The target impression designation unit 204 acquires the target impression of the plurality of commercial materials to be created from the impression sliders 508 to 511 and the radio buttons 512. Note that the multiple commercial material creation condition designation unit 201, the text designation unit 202, the image designation unit 203, and the target impression designation unit 204 may process the values set on the application activation screen 501. For example, the text designation unit 202 may remove an unnecessary blank character at the top or end of the input character information. Also, the target impression designation unit 204 may correct the values of the target impressions designated by the impression sliders 508 to 511.

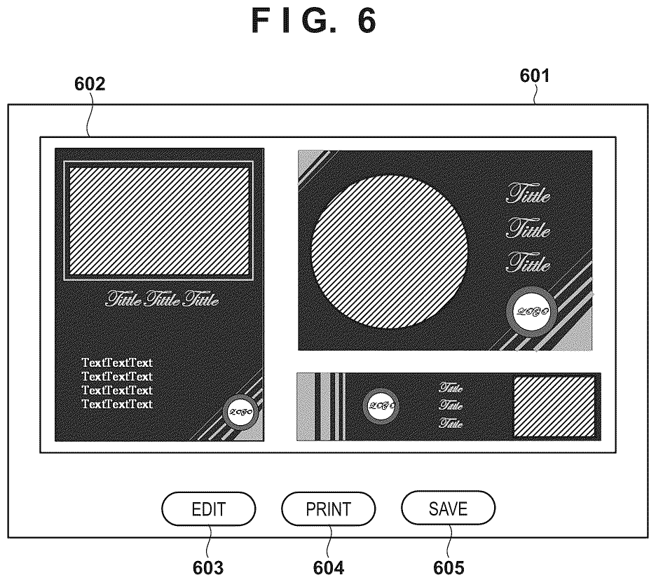

FIG. 6 is a view showing an example of a multiple commercial material preview screen in which the multiple commercial material images generated by the multiple commercial material display unit 205 are displayed on the display 105. When the OK button 522 on the application activation screen 501 is pressed, and multiple commercial material generation is completed, the screen displayed on the display 105 changes to a multiple commercial material preview screen 601.

A multiple commercial material image 602 is a commercial material image output by the multiple commercial material display unit 205. Since the multiple commercial material generation unit 210 generates commercial materials of types designated by the multiple commercial material creation condition designation unit 201, generated commercial materials of a plurality of types are displayed in a list as the multiple commercial material images 602 on the multiple commercial material preview screen 601. For example, if the user clicks a poster using the pointing device 107, the poster is selected.

An edit button 603 can edit the plurality of commercial materials in the selected state via a UI (not shown) that provides an editing function. A print button 604 can print the displayed commercial materials of the plurality of types via the control UI of a printer (not shown). A storage button 605 can store, in a re-editable state, setting information about the displayed commercial materials of the plurality of types in the HDD 104 using a predetermined format. The predetermined format may be the CSV format or the JSON format. The setting information to be stored is setting information on the application activation screen 501 shown in FIG. 5, and includes the estimated impression of each commercial material and brand information (a logo, a pattern, a key color, and a font).

### <Impression Quantification of Plurality of Commercial Materials>

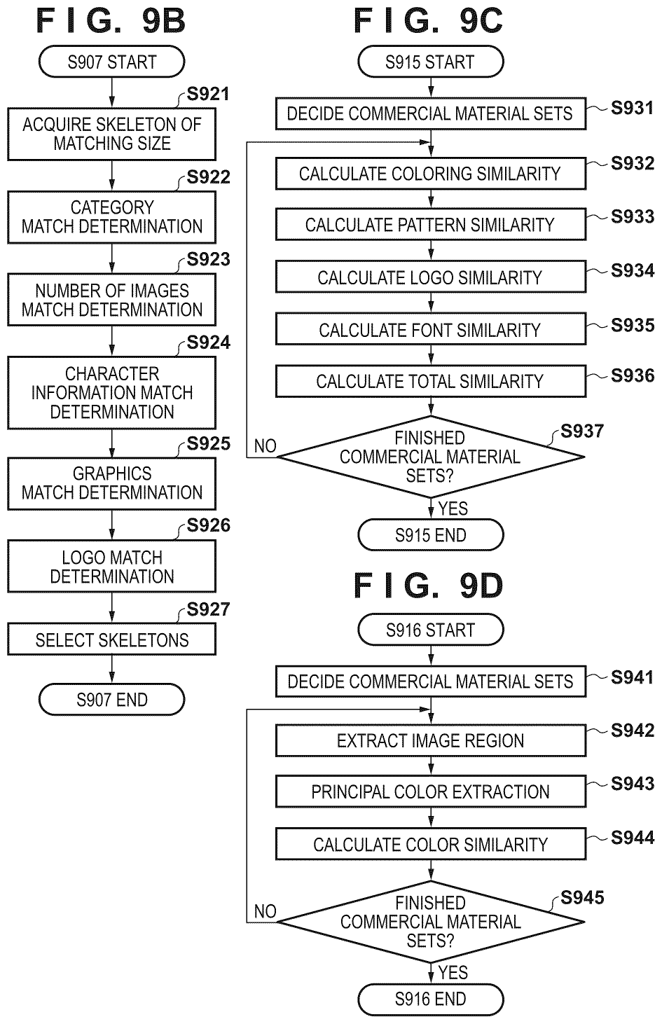

A method of processing of quantifying the impression of a plurality of commercial materials, which is preprocessing for executing impression estimation processing to be described later in S912 of FIG. 9A and is necessary for multiple commercial material generation processing, will be described here. In this embodiment, as an example, processing of quantifying the impression of a poster will be described. For other commercial materials as well, the impression can be quantified by performing the same processing. For commercial materials having close sizes or application purposes, the quantification result of an impression may be diverted.

The processing of quantifying the impression of a poster is performed at the development stage of the poster creation application by a vendor that develops the poster creation application. Note that the processing of quantifying the impression of a poster may be executed by the poster generation apparatus 100, or may be executed by an information processing apparatus different from the poster generation apparatus 100. Note that if the processing is executed by the information processing apparatus different from the poster generation apparatus 100, it is executed by the CPU of the information processing apparatus.

In the processing of quantifying the impression of a poster, an impression that a person has concerning various posters is quantified. At the same time, the correspondence relationship between a poster image and the impression of the poster is derived. This makes it possible to estimate the impression of the poster from the generated poster image. If the impression can be estimated, the impression of the poster can be controlled by correcting the poster image, or a poster image having a certain target impression can be searched for. Note that the poster impression quantification processing is executed by, for example, operating, in the poster generation apparatus, an impression learning application configured to learn the impression of a poster image in advance before poster generation processing.

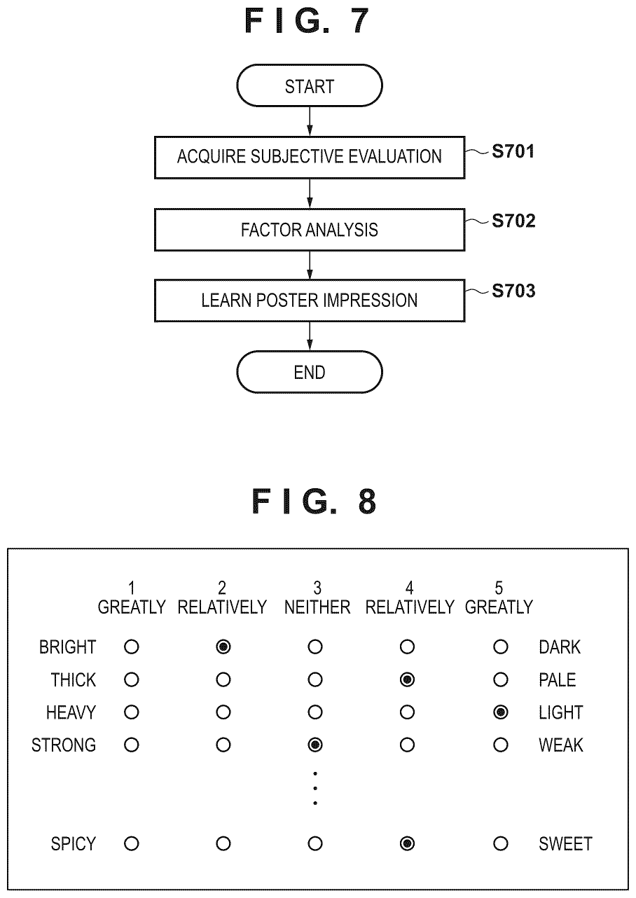

FIG. 7 is a flowchart showing poster impression quantification processing. The flowchart shown in FIG. 7 is implemented by, for example, the CPU 101 reading out a program stored in the HDD 104 to the RAM 103 and executing it. The poster impression quantification processing will be described with reference to FIG. 7. The processing shown in FIG. 7 is executed. Note that a symbol “S” in a description of each process means that it is a step in the flowchart (the same applies hereafter).

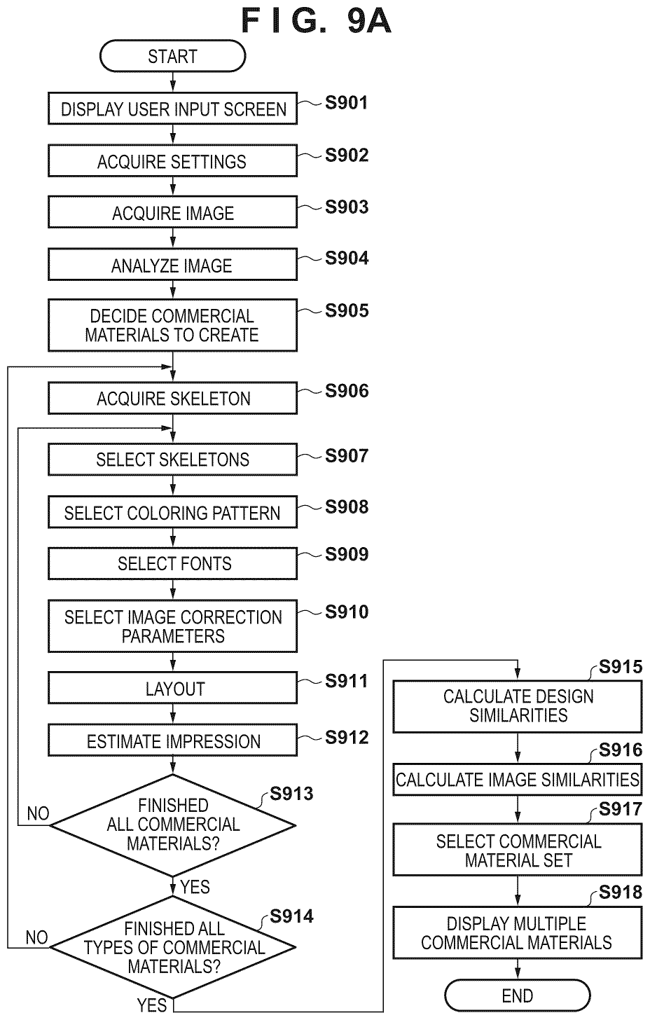

In S701, the CPU 101 executes acquisition of subjective evaluation of the impression of a poster. FIG. 8 is a view for explaining an example of a subjective evaluation method for the impression of a poster. The CPU 101 presents a poster to a subject, and acquires subjective evaluation of the impression of the poster from the subject. At this time, a measurement method such as the Semantic Differential (SD) method or the Likert scale method can be used. FIG. 8 shows an example of a questionnaire using the SD method. This is a questionnaire that presents adjective pairs expressing impressions to a plurality of evaluators and executes scoring concerning adjective pairs suggested from the target poster. After subjective evaluation results for a plurality of posters are acquired from the plurality of evaluators, the CPU 101 calculates the average value of answers for each adjective pair and thus obtains the average value as the representative score value of the corresponding adjective pair. Note that the subjective evaluation method for an impression may be any method other than the SD method if a word expressing an impression and a score corresponding to it are determined.

In S702, the CPU 101 executes factor analysis of the acquired subjective evaluation result. If the subjective evaluation result is directly used, the number of adjective pairs is the number of dimensions, and control is complex. It is therefore preferable to decrease the number of dimensions to an efficient number by an analysis method such as principal component analysis or factor analysis. In this embodiment, a description will be made assuming that the dimensions are decreased to four factors by factor analysis. This number changes depending on selection of adjective pairs in subjective evaluation and the factor analysis method, as a matter of course. Also, the output of factor analysis is standardized. That is, each factor is scaled such that the average is 0, and the variance is 1 in the poster used for analysis. Hence, −2, −1, 0, +1, and +2 of an impression designated by the target impression designation unit 204 can directly be made to correspond to −2σ, −1σ, average value, +1σ, and +2σ of each impression, respectively, and calculation of the distance between a target impression and an estimated impression to be described later is facilitated. Note that in this embodiment, a premium nature, a familiarity, a dynamism, and a profoundness shown in FIG. 5 are used as the four factors. These are names given for the sake of convenience to transmit impressions to the user via the user interface, and each factor is constituted by the plurality of adjective pairs affecting each other.

In S703, the CPU 101 associates a poster image with an impression. Quantification can be performed for the poster that has undergone the subjective evaluation of the above-described method, but an impression needs to be estimated without subjective evaluation even for a poster to be created from now on. Associating between a poster image and an impression can be implemented by learning a model for estimating an impression from a poster image using, for example, a deep learning method using a Convolution Neural Network (CNN) or a machine learning method using a decision tree. In this embodiment, in impression learning, supervised deep learning using a CNN is performed using a poster image as an input and four factors as outputs. That is, a deep learning model is created by performing learning using a poster image that has undergone subjective evaluation and a corresponding impression as a correct answer, and an unknown poster image is input to the learning model, thereby estimating the impression.

Note that the deep learning model created above is stored in, for example, the HDD 104, and the impression estimation unit 218 deploys the deep learning model stored in the HDD 104 onto the RAM 103 and executes it. The impression estimation unit 218 forms an image from poster data acquired from the layout unit 217, and estimates the impression of the poster by operating, by the CPU 101 or the GPU 109, the deep learning model deployed on the RAM 103. Note that in this embodiment, the deep learning method is used, but the present invention is not limited to this. For example, if a machine learning method such as a decision tree is used, a feature amount such as a luminance average value or an edge amount of a poster image may be extracted by image analysis, and a machine learning model that estimates an impression based on the feature amount may be created.

### <Image Correction Processing>

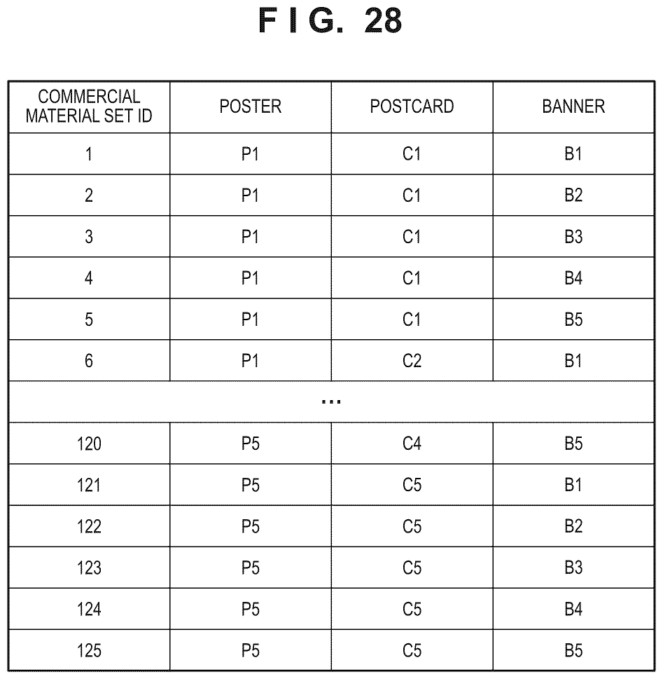

The image feature amount acquired by the image analysis unit 212, the image correction parameter selected by the image correction parameter selection unit 221, and image correction processing executed by the layout unit 217 will be described. FIG. 29 is a view showing a table in which an image feature amount is derived from a target impression. The table that derives an image feature amount is created by performing impression estimation for many images in advance and statistically analyzing the image feature amount corresponding to each impression value. In this embodiment, impression estimation for an image is performed by performing the above-described impression estimation processing for a poster adaptively to an image. In FIG. 29, the ordinate represents an impression, and the abscissa represents an image feature amount. For example, to impart a familiarity, as the image feature amount, the chroma and the number of colors are medium, and the edge amount is small. To impart a dynamism, the chroma is high, the hue is from red to orange, and the number of colors and the edge amount are large. To impart a profoundness, the chroma and the brightness are low. There also exists an impression value that cannot be controlled by the image feature amount, like a premium nature. If the impression cannot be controlled by the image feature amount, correction processing is not performed. The image analysis unit 212 acquires the image feature amount shown in FIG. 29.

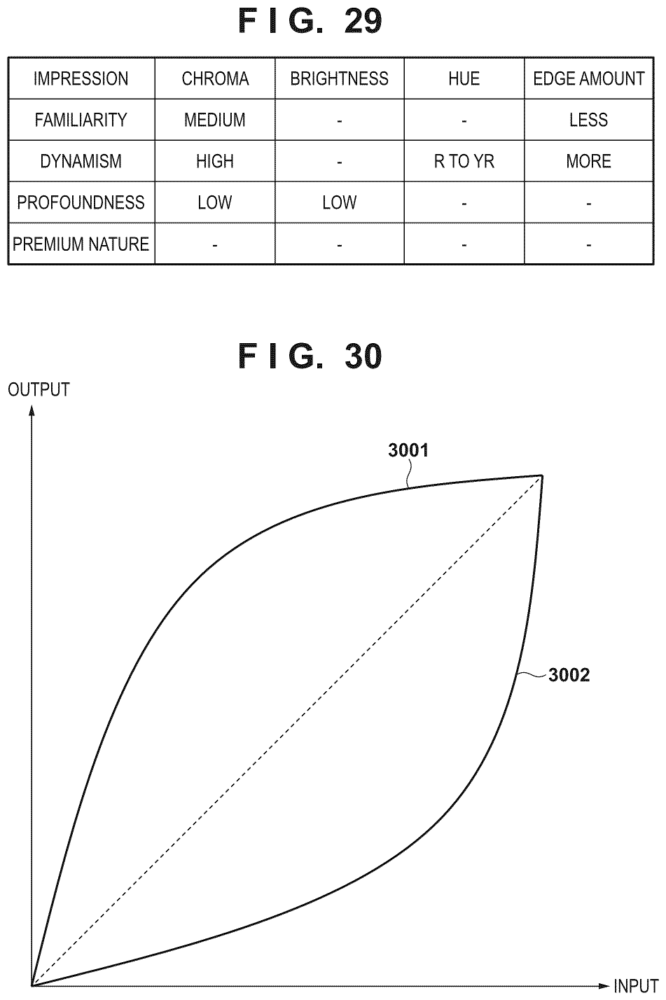

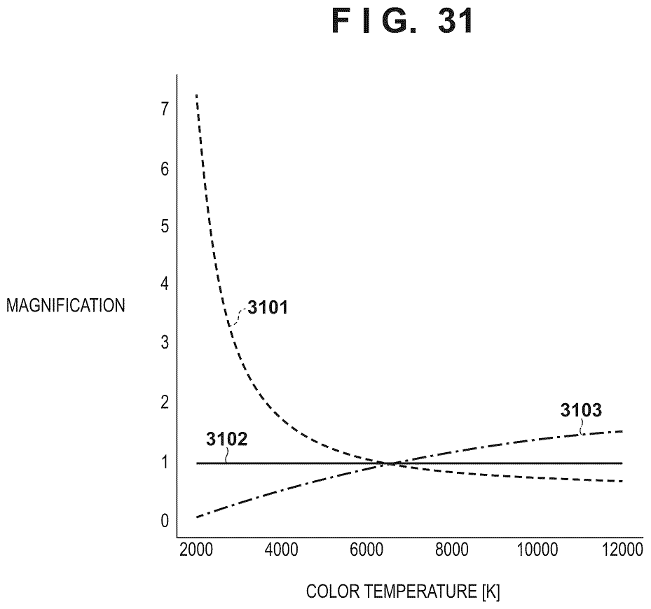

Image correction processing will be described next. For example, correction processing of setting the chroma of image data to medium is performed. Correction processing for the image feature amounts shown in FIG. 29 will be described as an example. As processing of correcting brightness or chroma, gamma correction is performed. FIG. 30 is a view schematically showing gamma curves used when performing gamma correction. The abscissa represents an input value, and the ordinate represents an output value. If image data is RGB data, it is converted into an LCH color space by a known technique, and gamma correction is performed for brightness L or chroma C. If gamma correction is performed using a gamma table 3001 with a shape projecting upward in FIG. 30, the brightness L or the chroma C becomes high. If gamma correction is performed using a gamma table 3002 with a shape projecting downward in FIG. 30, the brightness L or the chroma C becomes low. After gamma correction is performed, the data is inversely converted from the LCH color space to the RGB data by a known technique. In this embodiment, the chroma and the brightness are corrected using the gamma table, and finer correction may be performed using, for example, a Bézier curve. As the processing of correcting the hue, a method of correcting a hue H in the LCH color space is also usable, but a color cannot be added near a white point. In addition, if the hue is only simply changed, the color of a subject in the image is changed, resulting in discomfort. Hence, color temperature correction processing will be described as an example in this embodiment. A color temperature is a numerical value indicating the tint of a light source, and processing of correcting image data as if it was captured under a light source different from the image capturing environment is color temperature correction processing. By color temperature correction, a color near a white point can also be changed, and large discomfort is never felt even if the color of a subject changes. FIG. 31 shows an example of an RGB magnification when performing color temperature correction. A table 3101 indicates the magnification of R, a table 3102 indicates the magnification of G, and a table 3103 indicates the magnification of B. For example, to correct image data to a color temperature of 4,000 K, R of RGB data is increased to about 1.7 times, and B is increased to about 0.6 times. For this reason, a reddish color is obtained by correction. Note that to accurately correct the color temperature, the color temperature in an environment in which the image data is captured is necessary. In this embodiment, since the color temperature is used to change the hue, the color temperature in the image capturing environment is not always necessary. As processing of correcting the edge amount, sharpening filter or blur filter processing is used. When a sharpening filter is applied, the edge amount can be increased. When a blur filter is applied, the edge amount can be decreased. The sharpening filter can be implemented by, for example, adding a result obtained by applying a Laplacian filter to image data to the original image data. The blur filter can be implemented by, for example, using a Gaussian filter. Image correction processing can thus change the impression of an image by changing the image feature amount.

The image correction parameter will be described next. The image correction parameter is a parameter group necessary for performing each image correction processing described above. For example, in gamma correction, a gamma value used to decide a gamma curve is the image correction parameter, in color temperature correction, a color temperature used to decide a correction coefficient is the image correction parameter. Also, in the sharpening filter, the addition coefficient of a Laplacian filter is the image correction parameter, and in the blur filter, a σ value for adjusting the blur amount is the image correction parameter.

FIGS. 9A and 9B are flowcharts showing multiple commercial material generation processing by the multiple commercial material poster generation unit 210 of the multiple commercial material creation application. The flowcharts shown in FIGS. 9A and 9B are started when the user does the settings of various kinds of setting items on the multiple commercial material creation application and presses the OK button 522, as described above.

The flowchart shown in FIG. 9A is implemented by, for example, the CPU 101 reading out a program stored in the HDD 104 to the RAM 103 and executing it. In this embodiment, a description will be made assuming that the constituent elements shown in FIG. 2, which function when the CPU 101 executes the multiple commercial material creation application, execute the processing. Multiple commercial material generation processing will be described with reference to FIGS. 9A and 9B. Note that a symbol “S” in a description of each process means that it is a step in the flowchart (the same applies hereafter in this specification).

In S901, the multiple commercial material creation application displays the application activation screen 501 on the display 105. The user inputs each setting via the UI screen of the application activation screen 501 using the keyboard 106 or the pointing device 107.

In S902, the multiple commercial material creation condition designation unit 201, the text designation unit 202, the image designation unit 203, and the target impression designation unit 204 acquire corresponding settings from the application activation screen 501. The multiple commercial material creation condition designation unit 201 acquires the types of commercial materials to be created, a category, and brand information. As for the types of commercial materials to be created, the types of commercial materials to be created are acquired from the creation commercial material designation region 513. FIG. 5 shows, as an example, a state in which three types including “poster”, “banner”, and “postcard” are acquired. As for the category, the category is acquired from the category list box 514. FIG. 5 shows, as an example, a state in which the category is “food and drink”. As the brand information, a key color, a pattern, a logo, and a font are acquired. As the key color, a color designated in the key color designation box 515 is acquired. In addition, whether to use the key color for commercial material generation is acquired by the brand information enable radio button 519. FIG. 5 shows, as an example, a state in which the key color is a color expressed as light gray and is used for commercial material generation. As the pattern, a pattern designated in the pattern designation box 516 is acquired. In addition, whether to use the pattern for commercial material generation is acquired by the brand information enable radio button 519. FIG. 5 shows, as an example, a state in which the pattern is a tilted brick pattern and is used for commercial material generation. As the logo, a logo designated in the logo designating box 517 is acquired. In addition, whether to use the logo for commercial material generation is acquired by the brand information enable radio button 519. FIG. 5 shows, as an example, a state in which a logo is not designated and is not used for commercial material generation. As the font, a font designated in the font designation box 518 is acquired. In addition, whether to use the font for commercial material generation is acquired by the brand information enable radio button 519. FIG. 5 shows, as an example, a state in which a gothic-style font is designated as the font, but this is not used for commercial material generation.

The text designation unit 202 acquires character information to be arranged on the plurality of commercial materials from the title box 502, the subtitle box 503, and the text box 504. FIG. 5 shows, as an example, a state in which TitleTitleTitle is acquired as the title. As the subtitle, blank is acquired. As the text, four rows of TextTextText are acquired. The image designation unit 203 acquires an image designated in the image designation region 505. FIG. 5 shows, as an example, a state in which an image of backward diagonal hatching is acquired.

The target impression designation unit 204 acquires the factors of a target impression from the impression sliders 508 to 511. In addition, whether to use each factor as the target impression is acquired from the impression enable radio button 512. FIG. 5 shows, as an example, a state in which the premium nature is −1, the familiarity is +1, the dynamism is −0.8, and the profoundness is 0. Furthermore, the premium nature and the familiarity are used as target impressions, and the dynamism and the profoundness are not used as target impressions.

In S903, the image acquisition unit 211 acquires image data. More specifically, the image acquisition unit 211 specifies a corresponding image file for the image among the settings acquired in S902. The specified image file is read out from the HDD 104 to the RAM 103.

In S904, the image analysis unit 212 executes analysis processing for the image data acquired in S903 and acquires information indicating a feature amount. In this embodiment, the image feature amount shown in FIG. 29 is acquired.

In S905, the types of commercial materials to be created and the number of commercial materials to be created for each commercial material type are decided. The types of commercial materials to be created indicate the number of commercial material types acquired in S902. For example, the number is 3 in FIG. 5. Also, a predetermined number of commercial materials to be created is set for each commercial material type. In this embodiment, as an example, the number of commercial materials to be created is 5. That is, in FIG. 5, it is decided to create a total of 15 commercial materials including five posters, five postcards, and five banners. In this embodiment, a combination of commercial materials in which one commercial material is selected for each commercial material type is called a “commercial material set”. For example, FIG. 5 shows a state in which the combination of a total of three commercial materials including one poster, one postcard, and one banner is one commercial material set. In this embodiment, the number of commercial materials to be created is 5, but another number is also possible. If the number of commercial materials to be created is large, a commercial material set which is close to the target impression and in which the design similarity between commercial materials is high can readily be generated. If the number of commercial materials to be created is small, generation processing can be executed at a high speed.

Processing of S906 to S914 to be described later is repeated as many times as the number of types of commercial materials to be created, and processing of S907 to S913 is further repeated as many times as the number of commercial materials to be created. That is, processing of S907 to S913 is repeated as many times as the number of types of commercial materials to be created×the number of commercial materials to be created. In this embodiment, since the number of types of commercial materials to be created is 3, and the number of commercial materials to be created is 5, processing of S907 to S913 is repeated 15 times.

In S906, the skeleton acquisition unit 213 acquires a skeleton matching various kinds of set conditions in correspondence with each commercial material type as the processing target. In this embodiment, one skeleton is described in one file and stored in the HDD 104. The skeleton acquisition unit 213 sequentially reads out skeleton files from the HDD 104 to the RAM 103, leaves skeletons matching the conditions on the RAM 103, and erases skeletons not matching the conditions from the RAM 103. Here, FIG. 9B is a flowchart of condition determination processing performed by the skeleton acquisition unit 213. Condition determination processing of the skeleton acquisition unit 213 will be described in detail with reference to FIG. 9B. Processing of S921 to S927 is the sub-flow of S906.

In S921, the skeleton acquisition unit 213 determines, concerning each skeleton loaded to the RAM 103, whether the size set in advance for each commercial material type matches the size of the skeleton. For example, in FIG. 5, the size of the poster is A2, the size of the postcard is 100 mm×148 mm, and the size of the banner is 360 mm×45 mm. Note that, whether the sizes match is confirmed here, but only matching of aspect ratios may suffice. In this case, the skeleton acquisition unit 213 enlarges or reduces the coordinate system of the loaded skeleton, thereby acquiring a skeleton matching the size of the commercial material of the processing target.

In S922, the skeleton acquisition unit 213 determines whether the application purpose category designated by the multiple commercial material creation condition designation unit 201 matches the category of the skeleton. For a skeleton to be used only for a specific application purpose, the application purpose category is described in the skeleton file, and the skeleton is not acquired unless the application purpose category is selected. This can prevent the skeleton from being used in other application purpose categories in a case where the design of the skeleton is specialized for a specific application purpose, for example, in a case where a pattern reminding a school is drawn by a graphic, or a pattern of a sports gear is drawn. Note that if no application purpose category is set on the application activation screen 501, S922 is skipped.

In S923, the skeleton acquisition unit 213 determines whether the number of image objects in the loaded skeleton matches the number of images acquired by the image acquisition unit 211.

In S924, the skeleton acquisition unit 213 determines whether a character object in the loaded skeleton matches the character information designated by the text designation unit 202. More specifically, for example, the skeleton acquisition unit 213 determines whether the type of character information designated by the text designation unit 202 exists in the skeleton. For example, assume that character strings are designated in the title box 502 and the text box 504 on the application activation screen 501, and a blank field is designated in the subtitle box 503. In this case, all character objects in the skeleton are searched for, if both a character object for which “title” is set as the type of character information of metadata and a character object for which “text” is set are found, it is determined that “the type of character information exists”, and otherwise, it is determined that “the type of character information does not exist”.

In S925, the skeleton acquisition unit 213 determines whether a graphic object exists in the loaded skeleton. If a pattern is designated by the multiple commercial material creation condition designation unit 201, a graphic object needs to exist to draw the pattern. If a pattern is not designated by the multiple commercial material creation condition designation unit 201, S925 is skipped.

In S926, the skeleton acquisition unit 213 determines whether a logo object exists in the loaded skeleton. If a logo is designated by the multiple commercial material creation condition designation unit 201, an object needs to exist to draw the logo. If a logo is not designated by the multiple commercial material creation condition designation unit 201, S926 is skipped.

In S927, as the result of executing processing from S921 to S926, skeletons that satisfy the conditions of all the determination processes remain on the RAM 103. The skeleton acquisition unit 213 selects the skeletons remaining on the RAM 103 as skeletons to be used for poster generation.

As described above, the skeleton acquisition unit 213 holds, on the RAM 103, the skeletons that match the set conditions concerning all the skeleton size, the application purpose category, the number of image objects, the type of character object, the number of graphic objects, and the number of logo objects. Note that in this embodiment, the skeleton acquisition unit 213 determines all skeleton files on the HDD 104, but the present invention is not limited to this. For example, the multiple commercial material creation application may hold, in the HDD 104, a database that associates the file path of each skeleton file with search conditions. In this case, the skeleton acquisition unit 213 performs a search on the database and loads only adapted skeleton files from the HDD 104 to the RAM 103, thereby acquiring the skeleton files at a high speed. Note that the search conditions are, for example, the skeleton size, the number of image objects, the type of character object, the number of graphic objects, and the number of logo objects.

S906 has been described above. The explanation will return to FIG. 9A.

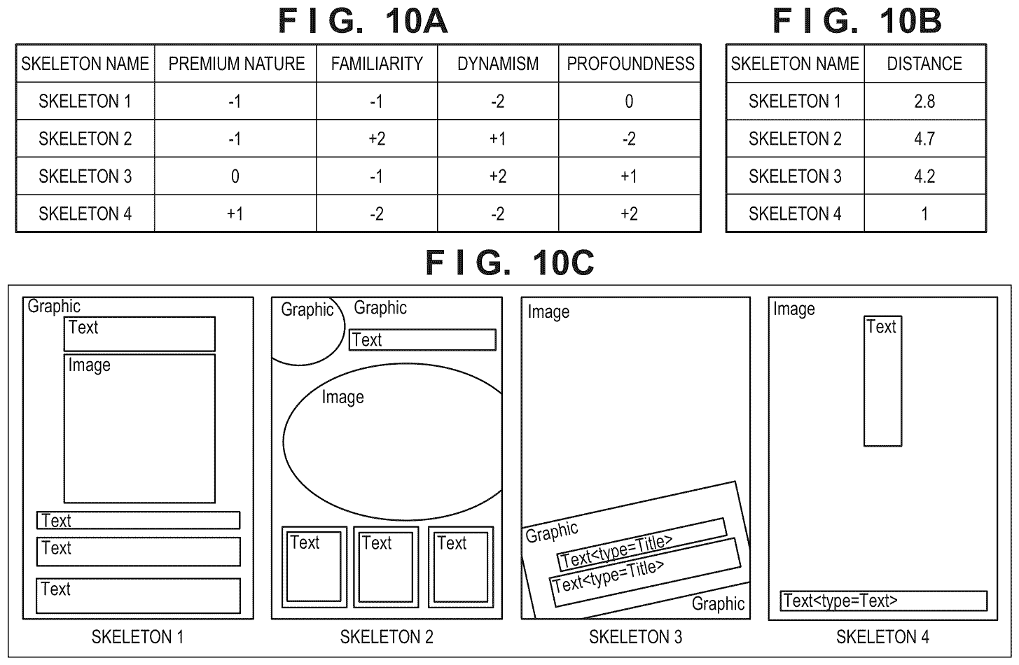

In S907, the skeleton selection unit 214 selects a skeleton matching the target impression designated by the target impression designation unit 204 among the skeletons acquired in S906. Here, FIGS. 10A to 10C are views for explaining a method of selecting a skeleton by the skeleton selection unit 214 as a skeleton of, for example, a poster. The same processing is executed even for other commercial material types. FIG. 10A is a view showing an example of a table that links skeletons with impressions. The file names of skeletons are described in the column of skeleton names in FIG. 10A, and the columns of a premium nature, a familiarity, a dynamism, and a profoundness show numbers (numerical values) each indicating the degree of influence the skeleton gives to the impression. As for these numerical values, “−2” indicates “low”, “−1” indicates “somewhat low”, “0” indicates “neither”, “+1” indicates “somewhat high”, and “+2” indicates “high” for the impression. First, the skeleton selection unit 214 calculates the distance between the target impression acquired from the target impression designation unit 204 and the impression of each skeleton shown in the skeleton impression table of FIG. 10A. For example, if the target impression is “premium nature+1, familiarity −1, dynamism −2, and profoundness +2”, distances shown in FIG. 10B are obtained as the distances calculated by the skeleton selection unit 214. Note that in this embodiment, a Euclidean distance is used as the distance (a simple distance is a Euclidean distance hereinafter). The smaller the value indicated by the Euclidean distance is, the closer the target impression and the impression of the skeleton are. Next, the skeleton selection unit 214 selects N high-rank skeletons for which the values indicating distances in FIG. 10B are small. In this embodiment, the skeleton selection unit 214 selects two high-rank skeletons. That is, the skeleton selection unit 214 selects skeleton 1 and skeleton 4. Here, as for a method of setting N, N needs only be an integer of 1 or more.

Also, the range of each impression in the skeleton impression table shown in FIG. 10A need not be the same as the range of the impression designated by the target impression designation unit 204. In this embodiment, the range of the impression designated by the target impression designation unit 204 is −2 to +2. However, the range of the impression in the skeleton impression table may be different from this. In this case, scaling is performed such that the range in the skeleton impression table matches the range of the target impression, and the distance calculation is performed after that. Also, the distance calculated by the skeleton selection unit 214 is not limited to the Euclidean distance, and any distance such as a Manhattan distance or a cosine similarity can be used if the distance between vectors can be calculated. Also, an impression for which the target impression is set to off by the radio button 517 is excluded from the distance calculation.

Note that the skeleton impression table is created in advance by, for example, fixing coloring patterns, fonts, and images and character data to be arranged on the skeletons, generating poster images based on the skeletons, and estimating impression thereof, and stored in the HDD 104. That is, the impressions of poster images in which the same character colors and the same images are used, but the arrangements of these are different are estimated, thereby forming a table showing the relative characteristics between the skeletons. At this time, processing of canceling the impression based on the used coloring pattern or image may be performed by standardizing the whole estimated impression or averaging the impressions of a plurality of poster images generated from one skeleton using a plurality of coloring patterns or images. This makes it possible to form a table of influences of arrangements on impressions in which, for example, the impression of a skeleton including a small image is determined not by the image but by an element such as a graphic or a character, and a high dynamism can be obtained if the arrangement of an image or characters is tilted.

FIG. 10C shows an example of skeletons corresponding to skeletons 1 to 4 in FIG. 10A. For example, in skeleton 1, since an image object and character objects are periodically arranged, and the area of the image is small, the dynamism is low. In skeleton 2, since a graphic object and an image object have a circular shape, the familiarity is high, and the profoundness is low. In skeleton 3, since a large image object is arranged, and a tilting graphic object is overlaid on the image object, the dynamism is high. In skeleton 4, since an image is arranged all over the skeleton, and a character object is minimum, the profoundness is high, and the dynamism is low. If a poster image includes characters or an image, poster images of different target impressions are generated depending on the arrangement method of the characters or the image. Note that the skeleton impression table creation method is not limited to this, and the impression may be estimated from the feature itself of arrangement information such as the area or the coordinates of an image or a title character string, or may be adjusted manually. The skeleton impression table is stored in the HDD 104, and the skeleton selection unit 214 reads out the skeleton impression table from the HDD 104 to the RAM 103 and refers to it.

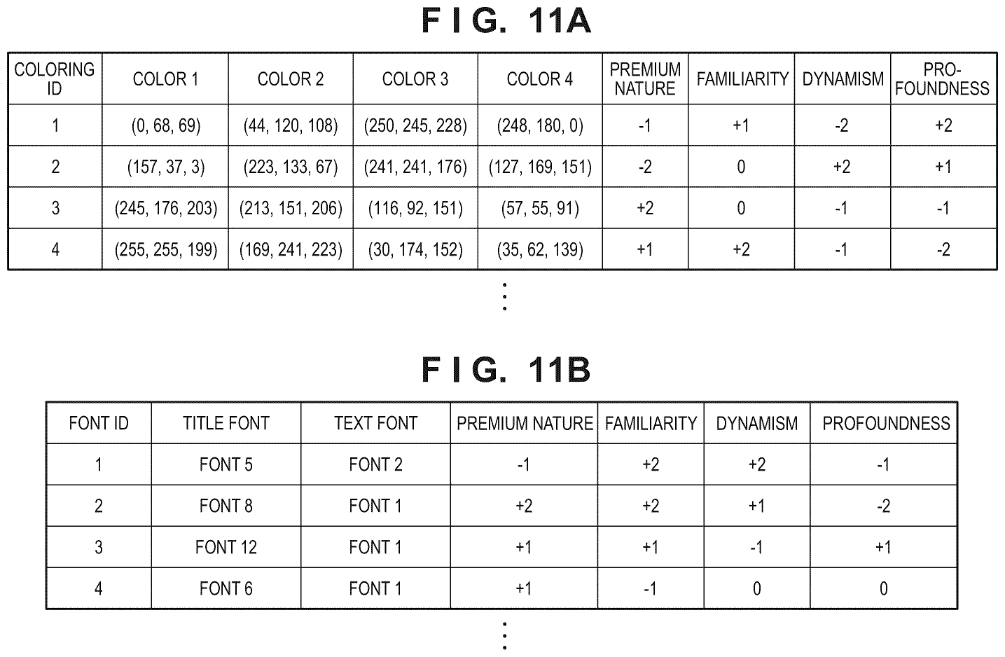

In S908, the coloring pattern selection unit 215 selects a coloring pattern matching the target impression designated by the target impression designation unit 204. Furthermore, if a color is designated by the multiple commercial material creation condition designation unit 201, a coloring pattern matching the designated color is selected. As for the method of selecting a coloring pattern matching the target impression, by the same method as in S906, an impression table corresponding to coloring patterns is referred to, and a coloring pattern is selected in accordance with the target impression. FIG. 11A shows an example of a coloring pattern impression table that links coloring patterns with impressions. The coloring pattern selection unit 215 calculates the value of the distance between the target impression and the value of the distance of each of impressions indicated by the column of the premium nature to the column of the profoundness in FIG. 11A, and selects N high-rank coloring patterns for which the values of the distances are small. In this embodiment, two high-rank coloring patterns are selected. Note that, like the skeleton impression table, the coloring pattern impression table can show, as a table, the tendencies of the impressions of the coloring patterns by fixing skeletons, fonts, and images other than the coloring patterns, creating posters in which the coloring pattern is changed, and estimating impressions. As for the method of selecting a coloring pattern matching the designated color, a color close to a color included in a coloring pattern is selected. For example, if a color whose distance ΔE in the CIE L*A*B* color space is 0.2 or less is included, the color is selected. Alternatively, the judgment criterion may be a distance ΔRGB of 1.0 or less in the RGB color space. More specifically, for example, if the designated color is (R, G, B)=(0, 67, 69), in FIG. 11A, color 1 of coloring ID 1 has the distance ΔRGB of 1.0 or less and is therefore selected.

In S909, the font selection unit 216 selects a combination of fonts matching the target impression designated by the target impression designation unit 204. Furthermore, if a font is designated by the multiple commercial material creation condition designation unit 201, a combination of fonts matching the designated font is selected. As for the method of selecting a font combination matching the target impression, by the same method as in S906, an impression table corresponding to fonts is referred to, and a font is selected in accordance with the target impression. FIG. 11B shows an example of a font impression table that links fonts with impressions. The font selection unit 216 calculates the value of the distance between the target impression and the value of the distance of each of impressions indicated by the column of the premium nature to the column of the profoundness in FIG. 11B, and selects N high-rank fonts for which the values of the distances are small. Note that, like the skeleton impression table, the font impression table can show, as a table, the tendencies of the impressions of the fonts by fixing skeletons, coloring patterns, and images other than the fonts, creating posters in which the font is changed, and estimating impressions. As for the method of selecting a font combination matching the designated font, for example, a font combination including the designated font is selected. Furthermore, a font combination close to the impression value of the fonts of the font combination including the designated font may further be selected. This can select a font close to the impression of the designated font.

In S910, the image correction parameter selection unit 221 selects image correction parameters in accordance with the image feature amounts acquired by the image analysis unit 212 and the target impression designated by the target impression designation unit 204. An example of a method of selecting image correction parameters matching the target impression will be described. The image feature amounts acquired by the image analysis unit 212 are the image feature amounts shown in FIG. 29. For example, if the familiarity in the target impression is a positive value, image correction parameters that make the chroma of the image after correction medium and the edge amount small are selected. As described above, in this embodiment, gamma correction is used as chroma correction, and a blur filter is used as edge amount correction. That is, if the chroma among the image feature amounts acquired by the image analysis unit 212 is high, a gamma value “2” is selected to apply a gamma table with a shape projecting downward. If the chroma is low, a gamma value “0.5” is selected to apply a gamma table with a shape projecting upward. Note that if the chroma is medium, a gamma value “1” is selected not to apply correction. Also, if the edge amount among the image feature amounts acquired by the image analysis unit 212 is large, a blur filter is applied to decrease the edge amount. In this embodiment, a Gaussian filter is used as the blur filter. Hence, the larger the correction intensity σ is, the larger the blur amount is. The closer the correction intensity σ is to 0, the smaller the blur amount is. For example, if the edge amount acquired by the image analysis unit 212 is large, 2 is selected as σ. If the edge amount is medium, the edge amount is corrected by selecting 1.5 as σ. As described above, when the image correction parameters are selected in accordance with the image analysis result and the target impression, the corrected image readily complies with the impression of the whole design. Note that as the image correction parameters, a plurality of image correction parameters are selected like the coloring pattern selected in S908 or the fonts selected in S909. For example, the target impressions are rearranged in descending order, and image correction parameters matching N high-rank target impressions are selected.

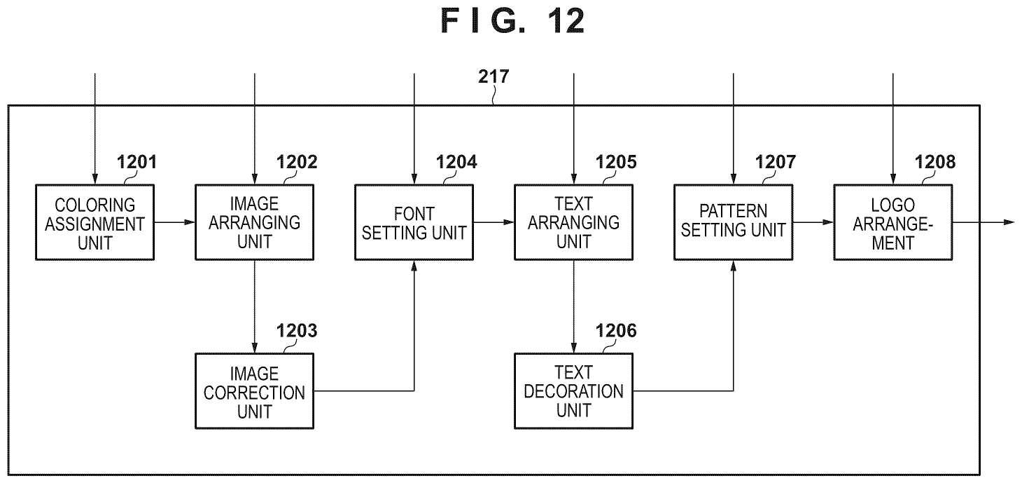

In S911, the layout unit 217 sets the character information, the images, the coloring, the fonts, the pattern, and the logo on the skeletons selected by the skeleton selection unit 214, and generates posters. S911 and processing of the layout unit 217 will be described in detail with reference to FIGS. 12, 13, 14A to 14C, and 15A to 15C.

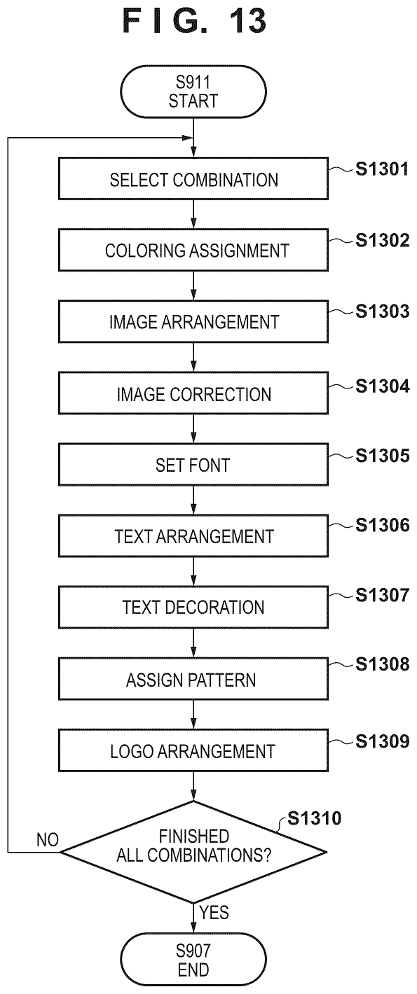

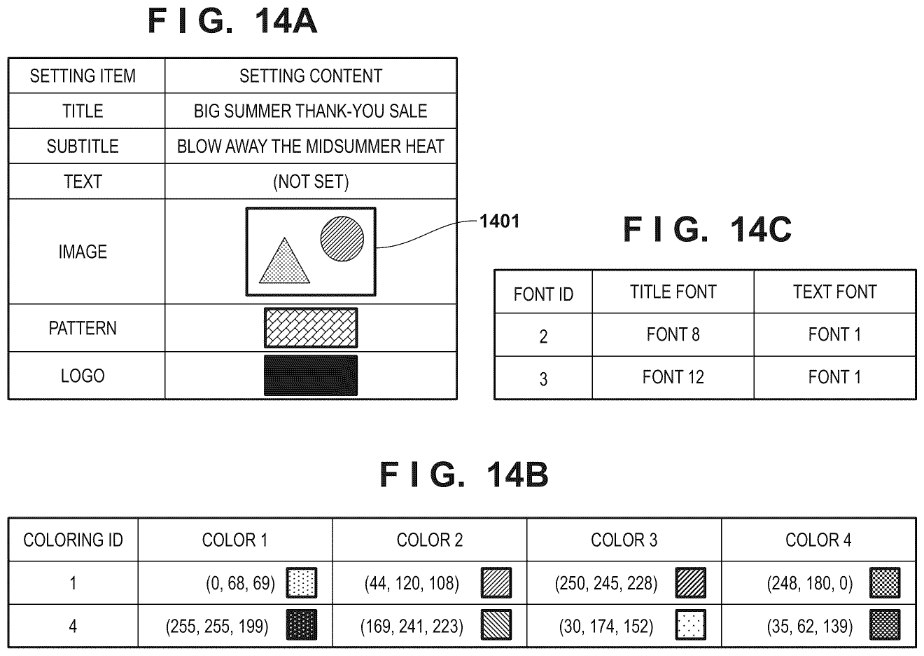

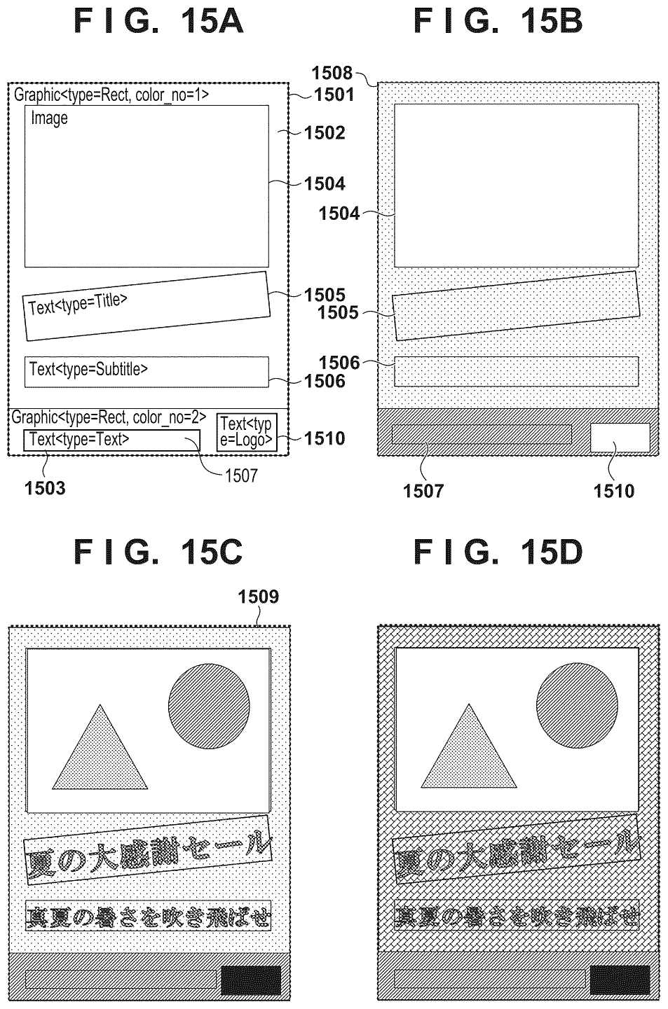

FIG. 12 shows an example of a software block diagram for explaining the layout unit 217 in detail. The layout unit 217 is configured by a coloring assignment unit 1201, an image arranging unit 1202, an image correction unit 1203, a font setting unit 1204, a text arranging unit 1205, a text decoration unit 1206, a pattern setting unit 1207, and a logo arranging unit 1208. FIG. 13 is a flowchart for explaining S911 in detail. FIGS. 14A to 14C are views for explaining an example of information input to the layout unit 217. FIG. 14A is a table showing character information designated by the text designation unit 202, an image designated by the image designation unit 203, and a pattern and a logo designated by the multiple commercial material creation condition designation unit 201. FIG. 14B is an example of a table showing coloring patterns acquired from the coloring pattern selection unit 215, and FIG. 14C is an example of a table showing fonts acquired from the font selection unit 216. FIGS. 15A to 15C are views for explaining the process of processing of the layout unit 217.

S911 will be described in detail with reference to FIG. 13. Processing of S1301 to S1310 is the sub-flow of S911.

In S1301, the layout unit 217 lists all combinations of the skeletons acquired from the skeleton selection unit 214, the coloring patterns acquired from the coloring pattern selection unit 215, and the fonts acquired from the font selection unit 216. The layout unit 217 performs the following layout processing sequentially for the combinations, thereby generating poster data. For example, if the number of skeletons acquired from the skeleton selection unit 214 is 3, the number of coloring patterns acquired from the coloring pattern selection unit 215 is 2, and the number of fonts acquired from the font selection unit 216 is 2, the layout unit 217 generates 3×2×2=12 poster data. Next, in S1301, the layout unit 217 selects one of the listed combinations and executes the processes of S1302 to S1309.

In S1302, the coloring assignment unit 1201 assigns a coloring pattern acquired from the coloring pattern selection unit 215 to a skeleton acquired from the skeleton selection unit 214. FIG. 15A is a view showing an example of the skeleton. In this embodiment, an example in which the coloring pattern of coloring ID “1” in FIG. 14B is assigned to a skeleton 1501 shown in FIG. 15A will be described. The skeleton 1501 shown in FIG. 15A is formed to include two graphic objects 1502 and 1503, one image object 1504, and three character objects 1505, 1506, and 1507. First, the coloring assignment unit 1201 performs coloring for the graphic objects 1502 and 1503. More specifically, a corresponding color is assigned from the coloring pattern based on a coloring number that is metadata described in each graphic object. Next, the coloring assignment unit 1201 assigns, for example, the final color of the coloring pattern to a character object for which the metadata is “type” and the attribute is “title” among the character objects. That is, in this example, color 4 is assigned to characters arranged in the character object 1505. Next, for the characters arranged in the character object other than the character object for which the metadata is “type” and the attribute is “title” among the character objects, a character color is set based on the brightness of the background of the character object. In this example, if the brightness of the background of the character object is equal to or less than a threshold, the character color is set to white. Otherwise, the character color is set to black. FIG. 15B is a view showing the state of a skeleton 1508 after the coloring assignment processing is performed. The coloring assignment unit 1201 outputs the skeleton data that has undergone the coloring to the image arranging unit 1202.

In S1303, the image arranging unit 1202 arranges, based on additional analysis information, the image data acquired from the image analysis unit 212 on the skeleton data acquired from the coloring assignment unit 1201. In this example, the image arranging unit 1202 assigns image data 1401 to the image object 1504 in the skeleton. Also, if the aspect ratio of the image object 1504 and that of the image data 1401 are different, the image arranging unit 1202 performs trimming such that the aspect ratio of the image data 1401 matches that of the image object 1504. More specifically, trimming is performed based on the position of the object obtained by the image analysis unit 212 analyzing the image data 1401 such that the object region reduced by the trimming is minimum. Note that the trimming method is not limited to this, and another trimming method of, for example, trimming the center of the image or devising the composition such that face positions implement a triangular composition may be used. The image arranging unit 1202 outputs the skeleton data that has undergone the image assignment to the image correction unit 1203.

In S1304, the image correction unit 1203 acquires the skeleton data that has undergone the image assignment from the image arranging unit 1202, and performs correction for the image arranged on the skeleton. In this embodiment, the image correction unit 1203 performs, for the image data arranged on the skeleton, image correction processing in accordance with the image correction parameters linked with the image data. That is, gamma correction processing of brightness and chroma, color temperature correction processing, and sharpening filter and blur filter processing are performed using the image correction parameters selected by the image correction parameter selection unit 221.

In S1305, the font setting unit 1204 sets the font acquired from the font selection unit 216 for the skeleton data that has undergone the image correction, which is acquired from the image correction unit 1203. FIG. 14C shows an example of combinations of fonts selected by the font selection unit 216. In this example, an example in which if the font to be assigned to the skeleton data that has undergone the image correction is font ID “2” shown in FIG. 14C, the font is assigned will be described. In this example, fonts are set for the character objects 1505, 1506, and 1507 on the skeleton 1508. Note that in many cases, in a poster, a noticeable font is assigned to the title from the viewpoint of attractiveness, and a font easy to read is assigned to the remaining characters from the viewpoint of visibility. For this reason, in this example, the font selection unit 216 selects two types of fonts including a title font and a text font. The font setting unit 1204 sets the title font for the character object 1505 whose attribute is “title” and the text font for the remaining character objects 1506 and 1507. The font setting unit 1204 outputs the skeleton data that has undergone the font setting to the text arranging unit 1205. Note that in this example, the font selection unit 216 selects two type of fonts, but the present invention is not limited to this and, for example, only the title font may be selected. In this case, the font setting unit 1204 uses the font corresponding to the title font as the text font. That is, if the title uses a gothic-style font, a representative gothic font with high readability is selected even for the remaining character objects, and if the title uses a Mincho-style font, a representative Mincho font is selected even for the remaining character objects, that is, a text font that matches the type of title font is set. The title font and the text font may be the same. Also, the fonts may be changed in accordance with the degree of making a font prominent such that, for example, the title font is used for the character objects of the title and the subtitle, and the text font is used for the remaining character objects, or the title font is used for a predetermined font size or more.

In S1306, the text arranging unit 1205 arranges the text designated by the text designation unit 202 on the skeleton data that has undergone the font setting, which is acquired from the font setting unit 1204. In this example, each text shown in FIG. 14A is assigned by referring to the attribute of the metadata of each character object on the skeleton. That is, “summer thanksgiving bargain sale” whose attribute is “title” is assigned to the character object 1505, and “blow away the summer heat” whose attribute is “subtitle” is assigned to the character object 1506. Since no “text” is set, nothing is assigned to the character object 1507. FIG. 15C shows a skeleton 1509 that is an example of skeleton data after the processing of the text arranging unit 1205. The text arranging unit 1205 outputs the skeleton data that has undergone the text arrangement to the text decoration unit 1206.

In S1307, the text decoration unit 1206 adds a decoration to each character object in the skeleton that has undergone the text arrangement, which is acquired from the text arranging unit 1205. In this example, if the color difference between the title characters and the background region thereof is equal to or less than a threshold, processing of adding an outline to the title characters is performed. This improves the readability of the title. The text decoration unit 1206 outputs the decorated skeleton data to the pattern setting unit 1207. In S1308, the pattern setting unit 1207 sets a pattern in the graphic object determined as a background region in the skeleton data having undergone text decoration and acquired from the text decoration unit 1206. Here, the graphic object determined as the background region is the graphic object of coloring number 1. In FIG. 15B, a pattern is set in the background region 1508. When setting the pattern, the color is changed to the coloring pattern assigned by the coloring assignment unit 1201, and after that, the pattern is set in the background region. FIG. 15D shows an example in which the pattern is already set. If no pattern is set by the multiple commercial material creation condition designation unit 201, a pattern set in the skeleton data may be set. The pattern setting unit 1207 outputs the skeleton data in which the pattern is set to the logo arranging unit 1208.

In S1309, the logo arranging unit 1208 arranges a logo in the logo object in the skeleton data having undergone pattern setting and acquired from the pattern setting unit 1207. FIG. 15D shows an example in which the logo is already arranged. If no logo is set by the multiple commercial material creation condition designation unit 201, S1309 is skipped. The logo arranging unit 1208 outputs the skeleton data in which the logo is arranged, that is, the commercial material data for which the layout is completed to the impression estimation unit 218.

In S1310, the layout unit 217 determines whether all commercial material data has been generated. Upon determining that, for the commercial materials of the processing target, commercial material data has been generated using all skeletons, coloring patterns, font combinations, patterns, and logos, the layout unit 217 ends the layout processing, and advances to S912. Upon determining that not all commercial material data has been generated, the process returns to S1301, and commercial material data is generated using a combination not used for generation.

S911 has been described above. The explanation will return to FIG. 9A.

In S912, the impression estimation unit 218 estimates the impression of each commercial material data generated in S911 and links it with the commercial material data. More specifically, rendering processing is executed for the commercial material data generated in S911. Next, the impression of the rendered commercial material image is estimated. Finally, the estimated impression is linked with the commercial material data. Note that the rendering processing means processing of converting commercial material data into image data. For example, even in the same coloring pattern, the arrangement changes if the skeleton changes. Hence, which color is actually used and in how much area the color is used change. For this reason, since it is necessary to evaluate not only the tendency of the impression of each coloring pattern or skeleton but also the final impression of the commercial material, this processing is executed at this timing. This can evaluate not only the impressions of the individual elements such as the arrangement and the coloring pattern of a commercial material but also the impression of the final commercial material in which the images and the characters are laid out.

In S913, it is determined whether all commercial material data are generated in accordance with the number of commercial materials of one commercial material type decided in S905. In this example, the number is 5. If commercial material data are not generated as many as the number of commercial materials to be created, the process returns to S907 to generate new commercial material data. If commercial material data are generated as many as the number of commercial materials to be created, the process advances to S915.

In S914, it is determined whether all commercial material data are generated in accordance with the types of commercial materials to be created, which are decided in S905. In this example, five commercial material data are generated for each of three commercial material types. That is, 15 commercial material data are generated. If commercial materials to be created are not generated for all commercial material types, the target commercial material type is changed, and the process returns to S906 to generate commercial material data as many as the number of commercial materials to be created for the newly set commercial material type. If commercial material data are generated for all commercial material types, the generation processing is ended, and the process advances to S915.

In S915, the design similarity calculation unit 219 calculates design similarities for the commercial material sets of all patterns obtained by combining all commercial material data acquired from the layout unit 217.

S915 will be described in detail with reference to FIG. 9C. Processing of S931 to S937 is the sub-flow of S915.

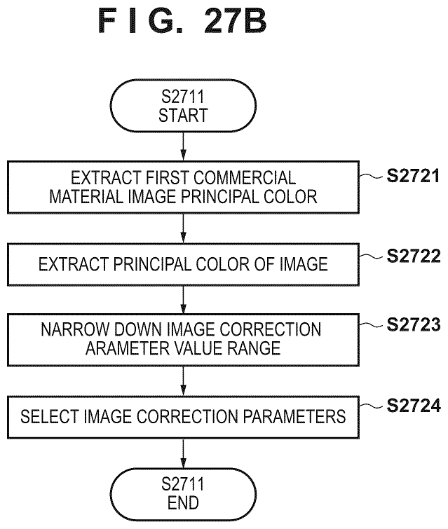

In S931, the design similarity calculation unit 219 decides all possible combinations of commercial material sets from the commercial material data generated by executing the processing of S906 to S914. More specifically, in this example, there are a total of 15 commercial material data including five posters, five postcards, and five banners. Five commercial material data of poster are represented by Pn (n=an integer of 1 to 5), five commercial material data of postcard are represented by Cn (n=an integer of 1 to 5), and five commercial material data of banner are represented by Bn (n=an integer of 1 to 5). In this case, there are 5×5×5=125 patterns of combinations of commercial material sets. FIG. 28 is a table showing an example of the combinations of the commercial material sets.

Processing of S932 to S936 is repetitively performed as many times as the number of commercial material sets decided in S931. Hereinafter, for the sake of simplification, a case where two commercial materials, that is, commercial material 1 and commercial material 2 are included in a commercial material set will be described. For example, commercial material 1 is a poster, and commercial material 2 is a postcard.

In S932, the design similarity calculation unit 219 calculates the similarity of coloring. As for the similarity of coloring, a degree representing how much used colors are similar is calculated. The smaller the similarity of coloring is, the higher the similarity indicated by the value is. More specifically, the similarity of coloring is calculated as a distance ΔE in the combination of the used coloring patterns in the CIE L*A*B* color space. Assume that coloring patterns used in commercial material 1 are coloring 1 and coloring 2, and coloring patterns used in commercial material 2 are coloring 3 and coloring 4. In this case, the sum of the distance ΔE between coloring 1 and coloring 3, the distance ΔE between coloring 1 and coloring 4, the distance ΔE between coloring 2 and coloring 3, and the distance ΔE between coloring 2 and coloring 4 in the CIE L*A*B* color space is obtained as the similarity of coloring. The similarity of coloring may be calculated using the ratio of an area to the total area of the commercial material with the colorings as a weight. In this case, rendering processing is executed for commercial material 1 and commercial material 2, and areas are calculated using commercial material 1 and commercial material 2 that have undergone the rendering. For the calculation expression of a similarity Mc of coloring, let Wc1 be the ratio of coloring 1 to the total area of commercial material 1, Wc2 be the ratio of coloring 2 to the total area of commercial material 1, Wc3 be the ratio of coloring 3 to the total area of commercial material 2, and Wc4 be the ratio of coloring 4 to the total area of commercial material 2. Letting ΔE13 be the distance ΔE between coloring 1 and coloring 3, ΔE14 be the distance ΔE between coloring 1 and coloring 4, ΔE23 be the distance ΔE between coloring 2 and coloring 3, and ΔE24 be the distance ΔE between coloring 2 and coloring 4, we obtain

$$Mc = Wc 1 \times Wc 3 \times Δ E 13 + Wc 1 \times Wc 4 \times Δ E 14 + Wc 2 \times Wc 3 \times Δ E 23 + Wc 2 \times Wc 4 \times Δ E 24$$

For example, assume that the ratio of coloring 1 to the total area of commercial material 1 is 0.5, the ratio of coloring 2 to the total area of commercial material 1 is 0.1, the ratio of coloring 3 to the total area of commercial material 2 is 0.3, and the ratio of coloring 4 to the total area of commercial material 2 is 0.2. Assume that the distance ΔE between coloring 1 and coloring 3 is 1, the distance ΔE between coloring 1 and coloring 4 is 2, the distance ΔE between coloring 2 and coloring 3 is 3, and the distance ΔE between coloring 2 and coloring 4 is 4. In this case, the similarity of coloring is 0.52.

In S933, the design similarity calculation unit 219 calculates the similarity of pattern. As for the similarity of pattern used in commercial materials, a degree representing how much the shapes of patterns are similar is calculated. The smaller the similarity of pattern is, the higher the similarity indicated by the value is. More specifically, for example, the similarity of pattern is calculated from the similarity of pattern contour. As the calculation method, an existing method may be used. For example, an edge extraction filter is applied to pattern images cut out in the same size, thereby generating contour images. The extracted contour images are superposed, and the number of pixels that are edge pixels in both patterns is calculated. A value indicating the similarity of pattern is calculated based on the ratio of the number of pixels that are edge pixels in both patterns to the total number of pixels of the pattern image. If the pattern is not used in one of the commercial materials, the value is maximum, indicating non-matching. If the pattern is used in both commercial materials, the value is zero, indicating matching. As the value as described above, for example, a value obtained by adding the squares of the differences between the pixel values of the contour image is used as a similarity.

In S934, the design similarity calculation unit 219 calculates the similarity of logo. As for the similarity of logo used in commercial materials, for example, a degree representing how much the shapes and colors of logos are similar is calculated. The similarity of logo shape is calculated by performing the same processing as in S932. The similarity of logo color is calculated based on the color difference ΔE between colors having the largest area in the logo. The similarity of logo is calculated as the sum of the similarity of logo shape and the similarity of logo color. The smaller the value of the similarity of logo is, the higher the similarity indicated by the value is.

In S935, the design similarity calculation unit 219 calculates the similarity of font. As for the similarity of font used in commercial materials, a degree representing how much the shapes and colors of fonts are similar is calculated. The similarity of font is calculated by performing the same processing as in S932 for character images obtained by rendering the same text. The smaller the value of the similarity of font is, the higher the similarity indicated by the value is. Also, the similarity of font may be calculated from the result of classification based on the types of fonts. For example, as the types of fonts of alphabets, there are serif and sans-serif. If both commercial materials use the same font, serif or sans-serif, the similarity of font is zero, indicating matching. If the commercial materials use different fonts, serif and sans-serif, the similarity of font is maximum, indicating non-matching. The similarity may be calculated based on the thickness difference between the fonts. For example, the similarity between a font of thickness 1 and a font of thickness 2 is 1.

In S936, the design similarity calculation unit 219 performs total evaluation of the similarities calculated in S932 to S935 and calculates a total similarity. The calculated total similarity is linked with each commercial material set and stored in the RAM 103. Since the similarities have different ranges, all the commercial material sets are wholly standardized. The total similarity is calculated as the sum of the standardized similarities. The similarities may be weighted and added. It is known that when recognizing the similarity of design, the influence of the color or shape is strong, and the degree of influence of the font or logo is low. For this reason, when the weights for the similarity of coloring and the similarity of pattern are increased, and the weights for the similarity of logo and the similarity of font are decreased, evaluation of human recognizing same design can be simulated. As for the method of deciding a weight, the weight can be calculated by subjective evaluation.

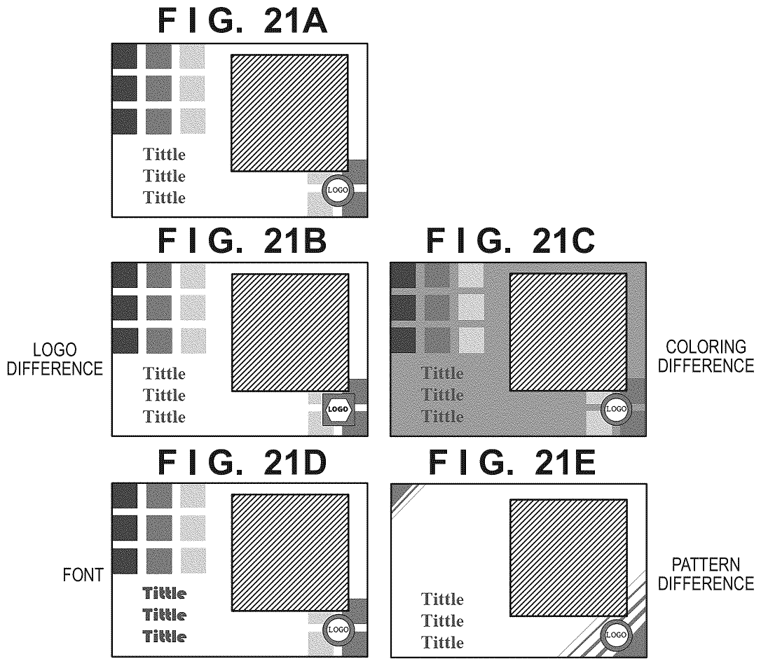

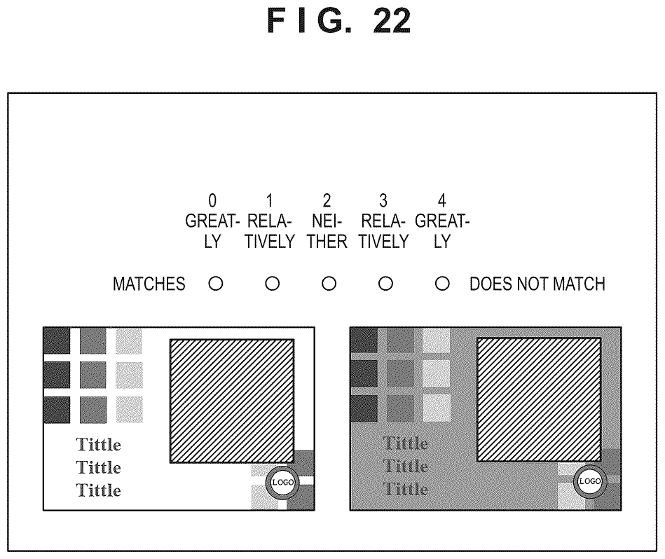

FIGS. 21A to 21E and FIG. 22 are views for explaining subjective evaluation for deciding a weight between design elements. For example, a commercial material as shown in FIG. 21A is created as one reference. Commercial materials each of which has only one design element changed from the commercial material serving as the reference are created. For example, a commercial material in which only the logo is changed, as shown in FIG. 21B, a commercial material in which only the coloring is changed, as shown in FIG. 21C, a commercial material in which only the font is changed, as shown in FIG. 21D, and a commercial material in which only the pattern is changed, as shown in FIG. 21E are generated. The commercial material serving as the reference and each changed commercial material are compared, and subjective evaluation of judging how much these are identical is performed. For example, evaluation values “5” (not match at all) to “0” (pretty similar) are set, as shown in FIG. 22, and a plurality of subjects are caused to do subjective evaluation of comparing the reference commercial material with the commercial material having the different coloring. The same evaluation is performed for each of the commercial materials with the different pattern, the different logo, and the different font. The average value of evaluation values of the plurality of subjects is calculated. If the average value is large, the commercial material is evaluated not to be similar. For this reason, it can be estimated that if the design is even slightly different, it is readily judged that the design is not similar. Hence, when calculating the design similarity, the weight of the design element is increased. On the other hand, if the average value is small, the commercial material is evaluated to be similar. For this reason, it can be estimated that if the design is only slightly different, it is readily judged that the design is similar. Hence, when calculating the design similarity, the weight of the design element is decreased. More specifically, as the weight calculation method, defining the sum of the average values of the design elements as 1, the ratio of the average value of each design element is obtained as the weight. This makes it possible to appropriately generate a plurality of commercial materials having a unified design between the plurality of commercial materials. In the above description, since the commercial material set includes two commercial materials, only one design similarity is obtained. However, if the commercial material set includes three or more commercial materials, there are a plurality of combinations of two commercial materials, and a plurality of design similarities are calculated. More specifically, if the commercial material set includes commercial material 1, commercial material 2, and commercial material 3, three design similarities between commercial material 1 and commercial material 2, between commercial material 2 and commercial material 3, and between commercial material 3 and commercial material 1 are calculated. If the commercial material set includes three or more commercial materials, the design similarity calculation unit 219 obtains the sum of the plurality of design similarities as the design similarity of the commercial material set. The design similarity calculation unit 219 links the calculated design similarity with the commercial material set and stores it.

S915 has been described above. The explanation will return to FIG. 9A.

In S916, the image similarity calculation unit 222 calculates image similarities for the commercial material sets of all patterns obtained by combining all commercial material data acquired from the layout unit 217, as in S915.

S916 will be described in detail with reference to FIG. 9D. Processing of S941 to S945 is the sub-flow of S916.

In S941, the image similarity calculation unit 222 decides all possible combinations of commercial material sets from the commercial material data generated by executing the processing of S906 to S914. Detailed processing is the same as S931, and a description thereof will be omitted here.

Processing of S942 to S945 is repetitively performed as many times as the number of commercial material sets decided in S941. Hereinafter, for the sake of simplification, a case where two commercial materials, that is, commercial material 1 and commercial material 2 are included in a commercial material set will be described. For example, commercial material 1 is a poster, and commercial material 2 is a postcard.

In S942, the image similarity calculation unit 222 extracts an image region from the commercial material data. An image arranged on a skeleton is sometimes trimmed in the process of arrangement or hidden by another object superposed on the image. The image similarity calculation unit 222 specifies the visible region of the image data arranged on the skeleton and extracts pixel data.

In S943, the image similarity calculation unit 222 extracts a color with the highest appearance frequency as a principal color from the pixel data extracted in S942.

In S944, the image similarity calculation unit 222 calculates the similarity between the principal color of commercial material 1 and the principal color of commercial material 2, which are extracted in S943. Here, the similarity of color is calculated by the color difference ΔE. Note that in this embodiment, the similarity is calculated using one principal color. However, N high-rank principal colors may be extracted, and the sum of similarities may be calculated. The image similarity may be calculated using another index such as the average luminance value or the edge amount of the image. For example, an intermediate feature amount of an image recognizer by machine learning that is a known technique is used as an index, and the cosine similarity between two intermediate feature amounts is calculated. This makes it possible to calculate a similarity in consideration of a composition other than colors or contents in the image as well. The image similarity calculation unit 222 links the calculated image similarity with the commercial material set and stores it.

S916 has been described above. The explanation will return to FIG. 9A.

In S917, the multiple commercial material selection unit 220 selects a commercial material set to be output to the display 105 (presented to the user) based on the estimated impression acquired from the impression estimation unit 218, the design similarity acquired from the design similarity calculation unit 219, and the image similarity acquired from the image similarity calculation unit 222. More specifically, first, the multiple commercial material selection unit 220 calculates the impression distance between the estimated impression linked with the commercial material set and the target impression. The calculated impression distance is linked with the commercial material data and stored. In this example, since 15 commercial material data are generated, 15 impression distances are calculated. A Euclidean distance is used as the impression distance. The smaller the value indicated by the Euclidean distance is, the closer the target impression and the estimated impression are. Also, the distance calculated by the design similarity calculation unit 219 is not limited to the Euclidean distance, and any distance such as a Manhattan distance or a cosine similarity can be used if the distance between vectors can be calculated. Next, the multiple commercial material selection unit 220 calculates the total impression distance for each commercial material set. In this example, one commercial material set includes three commercial materials including a poster, a postcard, and a banner. The total impression distance is calculated by adding the three calculated impression distances. The calculated total impression distance is linked with the commercial material set and stored.

Next, the multiple commercial material selection unit 220 calculates the sum of the total impression distance, the design similarity, and the image similarity, which are linked with each commercial material set. The multiple commercial material selection unit 220 selects a commercial material set based on the calculated sums. In this example, since one commercial material set is displayed on the preview screen 601 shown in FIG. 6, a commercial material set for which the sum is smallest is selected. If a plurality of commercial material sets are displayed on the preview screen, high-rank commercial material sets as many as the number of displayed commercial material sets are selected in ascending order of sum. Alternatively, a commercial material set for which the sum is equal to or less than a predetermined threshold may be selected. In this case, if commercial material sets as many as the number of commercial material sets displayed on the preview screen cannot be selected, the process may return to S907 to generate another commercial material data. Which one of the impression distance, the design similarity, and the image similarity should be given priority is decided based on the reflection level of brand information designated by the multiple commercial material creation condition designation unit 201. If a weight is added to each of the total impression distance, the design similarity, and the image similarity when totalizing these, the priority can be decided based on the reflection level. For example, if the reflection level is 0.4, as shown in FIG. 5, the sum is calculated while setting the weight of the impression distance to 0.6 and the weight of the design similarity and the image similarity to 0.2. This allows the user to adjust the priority of an impressive matching level and the matching level as the brand using the reflection level slider bar 520 on the application activation screen 501, and a commercial material more complying with the intention of the user can automatically be generated.

In S918, the multiple commercial material display unit 205 displays the preview screen 601 shown in FIG. 6. More specifically, a plurality of commercial material data included in the commercial material set selected by the multiple commercial material selection unit 220 in S917 are rendered and output to the display 105.

Multiple commercial material generation processing of generating a plurality of commercial materials by designating the impression by the user has been described above.

As described above, according to this embodiment, even if different images are arranged on a plurality of commercial materials, it is possible to automatically generate commercial materials that give a sense of unity and give the impression of a brand intended by a user. More specifically, in this embodiment, to generate a design that gives the impression of a brand intended by the user, in each commercial material, elements forming the commercial material such as a skeleton, a coloring pattern, a font, and image correction parameters are combined based on the target impression. Furthermore, by estimating the impression of the whole commercial material and selecting a commercial material close to the target impression from one or a plurality of poster candidates, it is possible to generate a commercial material in which not only single elements but also the overall impression complies with the intention of the user. Furthermore, to generate a design that gives a sense of unity, the design similarity and the image similarity between commercial materials are calculated, thereby selecting a design in which the similarity level of design elements is high and displaying this.

### Modification of First Embodiment

In the first embodiment, the preview screen 601 displays the generated commercial material set. However, setting of the target impression and setting of the brand information may be done on the preview screen.

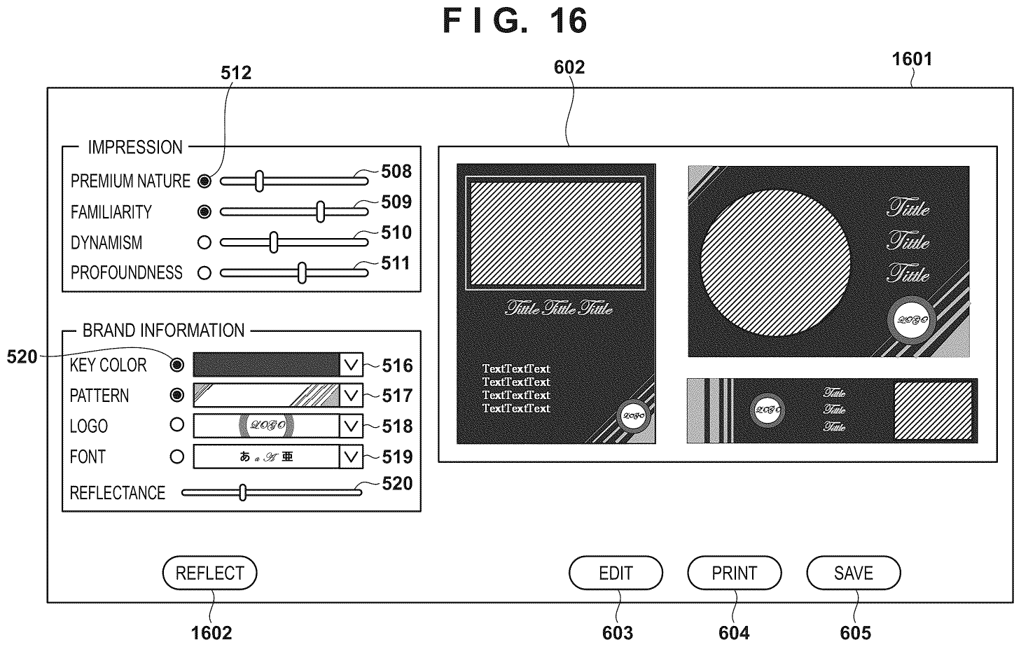

FIG. 16 is a view showing an example of a UI configured to set a target impression and set brand information on a preview screen 1601. The components denoted by the same reference numerals as in FIG. 5 perform the same operations as in FIG. 5. The components denoted by the same reference numerals as in FIG. 6 perform the same operations as in FIG. 6. The multiple commercial material display unit 205 displays the preview screen 1601 in S918. In the preview screen 1601, the impression sliders 508 to 511 and the impression enable radio button 512 in the application activation screen 501 are arranged as UIs configured to set a target impression. In addition, the key color designation box 515, the pattern designation box 516, the logo designating box 517, the font designation box 518, and the reflection level slider bar 520 are arranged as UIs configured to set brand information. Furthermore, a reflection button 1602 configured to reflect the set information is provided in the preview screen 1601. The user changes the target impression and the brand information while confirming the preview image 601. By pressing a reflection button 1602, the process advances to S902 in FIG. 9, and the processes of S902 to S918 are executed. As the result of execution, the multiple commercial material display unit 205 displays the preview image 601 on which the settings of the target impression and the brand information set on the preview screen 1601 are reflected. This makes it possible to set the target impression and the brand information while confirming the generation result of the commercial material set. As a result, it is possible to automatically generate designs that give a sense of unity and give the impression of a brand intended by a user without making cumbersome screen transition.

In the first embodiment, setting of the target impression and setting of the brand information are done on the activation screen 501. However, if the user does not know about an impression or a brand, it is difficult to set the impression or the brand information on the activation screen 501. Since setting is repetitively done while observing the commercial material generation result, the operation is cumbersome. In this embodiment, the target impression and the brand information may be reflected from the generation result of one commercial material on another commercial material. More specifically, a plurality of commercial materials on which various impressions and brands are reflected are displayed in correspondence with one commercial material type, and one of these is selected. The target impression and the brand information are acquired from the selected commercial material, and a commercial material of another commercial material type is generated. Hence, even if the user does not know about an impression or a brand, it is possible to automatically generate designs that give a sense of unity and give the impression of a brand intended by a user without repetitively doing setting.

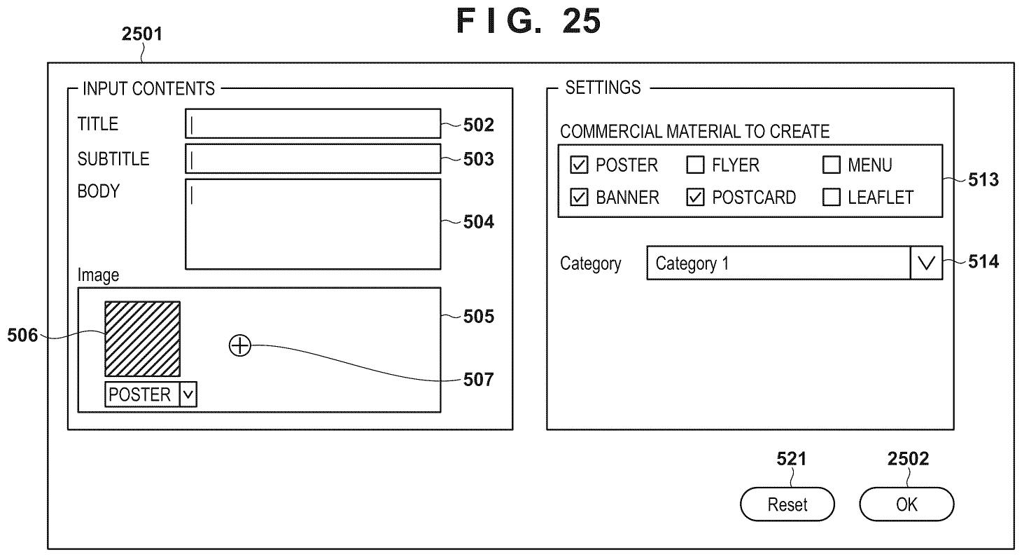

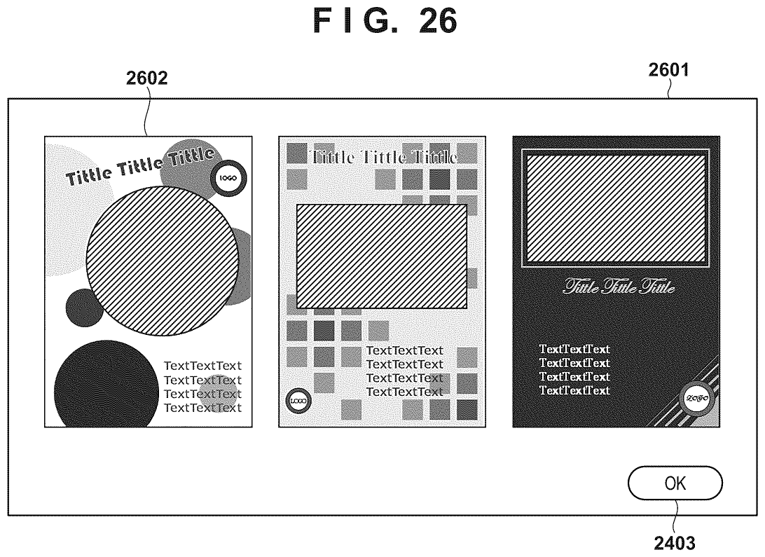

FIG. 25 is a view showing an example of an application activation screen 2501 provided by the multiple commercial material creation application according to this embodiment. The components denoted by the same reference numerals as in FIG. 5 perform the same operations as in FIG. 5. As shown in FIG. 25, as compared to the application activation screen 501, the UIs configured to set an impression and brand information do not exist. When an OK button 2502 is pressed, commercial materials of various variations with different target impressions and brand information are generated for the commercial material type at the upper left position among the commercial material types selected in the creation commercial material designation region 513. If the commercial materials are generated, the multiple commercial material display unit 205 displays the generated commercial materials on a preview screen 2601 shown in FIG. 26. As an example, in this embodiment, the generation result of the commercial materials of various variations is displayed. Next, the user selects a poster matching the intention from the poster commercial materials displayed in a commercial material image 2602. When an OK button 2403 is pressed after selection, the target impression and the brand information are acquired from the selected poster commercial material, and a commercial material of another commercial material type is generated. When another commercial material is generated, the screen transitions to the preview screen 601 shown in FIG. 6. In this embodiment, as an example, the commercial material set displayed as a preview in FIG. 6 represents that the poster on the rightmost side among posters displayed on the preview screen 2601 in FIG. 26 is selected.

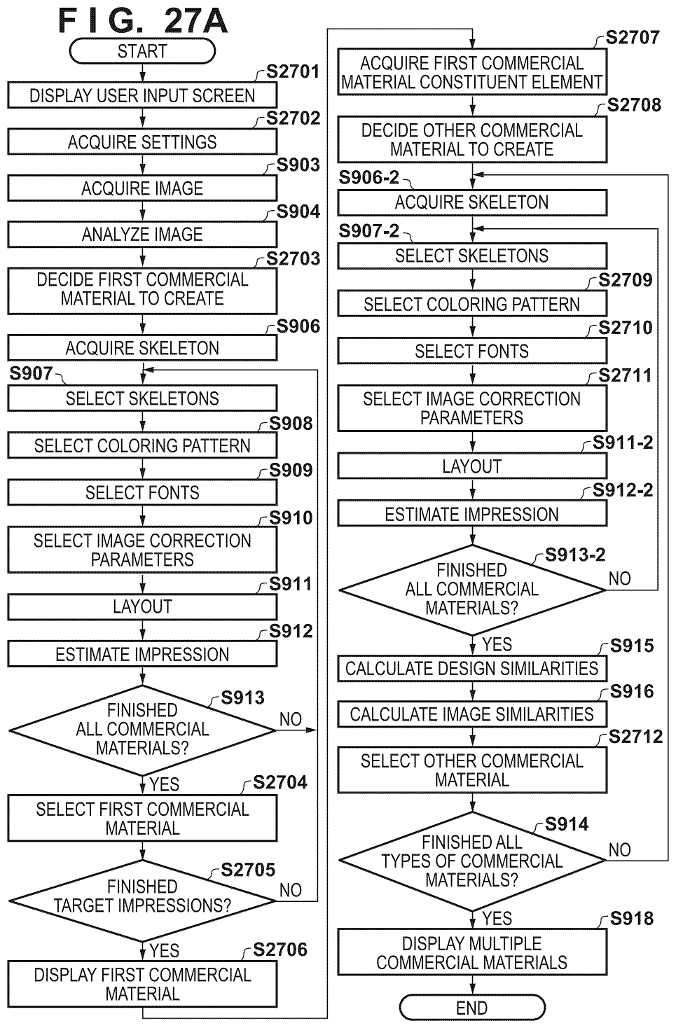

FIG. 27A is a flowchart showing multiple commercial material generation processing according to this embodiment. Note that in the processing of this flowchart, processes indicated by the same numbers as in the flowchart of FIG. 9 execute the same processes described in the first embodiment, and a description thereof will be omitted here. Note that in the processing of this flowchart, S901, S902, S905, S915, S916, and S917 shown in FIG. 9 are omitted.

In S2701, the multiple commercial material creation application displays the application activation screen 2501 on the display 105. The user inputs each setting via the UI screen of the application activation screen 2501 using the keyboard 106 or the pointing device 107.

In S2702, the multiple commercial material creation condition designation unit 201, the text designation unit 202, and the image designation unit 203 acquire corresponding settings from the application activation screen 2501. The text designation unit 202 and the image designation unit 203 acquire the settings by executing the same process as in S902. The multiple commercial material creation condition designation unit 201 acquires the types of commercial materials to be created and a category by executing the same process as in S902.

After S904 in FIG. 27A, in S2703, a first commercial material type to be generated in various variations and displayed on the preview screen 2601 and a target impression to be generated are decided. As the first commercial material type, the commercial material type displayed at the upper left position among commercial materials selected by the multiple commercial material creation condition designation unit 201 is selected. In this example, a poster is selected. Also, it may be changed to a commercial material type in which the user can confirm an impression and brand information. For example, a commercial material including a logo, a font, a coloring, and a pattern, which are examples of brand information, as design elements may be selected. Next, to make various variations, the target impression designation unit 204 discretely decides a plurality of patterns of the target impression. As an example, three patterns in which the dynamism is +2 (the remaining impressions are 0), the dynamism is −2 (the remaining impressions are 0), and the premium nature is +2 (the remaining impressions are 0) may be decided. To make various variations, target impression values are preferably apart on the impression space. Furthermore, for one target impression pattern, a number decided in advance is decided as the number of commercial materials to be created. In this embodiment, the number is set to 5 as an example. That is, in this embodiment, five poster commercial materials are generated for each of three target impression patterns. In this example, the processes of S907 to S913 in FIG. 27A are executed, thereby generating five poster commercial materials for one target impression pattern.

After S913, in S2704, the multiple commercial material selection unit 220 selects, based on the estimated impression acquired from the impression estimation unit 218, one commercial material from the plurality of commercial materials created for one target impression pattern. More specifically, first, the multiple commercial material selection unit 220 calculates the impression distance between the estimated impression linked with the commercial material data and the target impression, as in S917 of FIG. 9. Next, a commercial material for which the impression distance is minimum is selected. The selected commercial material is stored in the RAM 103. The selected commercial material is displayed on the preview screen 2601 in S2706 to be described later.

In S2705, it is judged whether commercial materials as many as the number of target impressions decided in S2703 are selected in S2704. In this example, the number is 3. If commercial materials as many as the number of target impressions are not selected, the target impression designation unit 204 changes the target impression pattern to the next target impression pattern and then advances to S907. If commercial materials as many as the number of target impressions are selected, the process advances to S2705.

In S2706, the commercial materials selected in S2704 are displayed on the preview screen 2601, and the user is caused to select one of them. The commercial material data selected by the user is stored in the RAM 103.

In S2707, a target impression and brand information are acquired from the commercial material data selected by the user in S2706. The target impression to be acquired is the estimated impression linked with the commercial material data selected by the user. The brand information to be acquired includes at least one of a logo, a coloring pattern, a font, and a pattern included in the commercial material data selected by the user and image data included in the commercial material data. If there is commercial material data not including a logo, a coloring pattern, a font, and a pattern, the brand information is not acquired. This makes it possible to commonly use at least one of a logo, a coloring pattern, a font, and a pattern in the skeletons of different commercial materials.

In S2708, based on the setting acquired in S2702 and the target impression and the brand information acquired in S2707, a commercial material of a commercial material type different from the first commercial material type is decided as a commercial material type to be generated. In an example, in FIG. 25, two commercial material types, that is, a postcard and a banner are decided. Furthermore, a number decided in advance for one commercial material type is decided as the number of commercial materials to be created. In this example, the number is 5. By executing the processes of S906-2 to S913-2, five commercial materials are generated for one commercial material type. S906-2, S907-2, S911-2, S912-2, and S913-2 are the same as described concerning S906, S907, S911, S912, and S913.

After S907-2, in S2709, the coloring pattern selection unit 215 selects a coloring pattern matching the target impression and the brand information acquired in S2707. First, the coloring pattern selection unit 215 narrows down all coloring patterns to only coloring patterns having close distances to the coloring pattern acquired in S2707. The distance between two coloring patterns can be calculated by the sum of the color differences ΔE between colors included in the coloring patterns. In this example, a coloring pattern has four colors, as shown in FIG. 11A. Hence, as coloring patterns close to the coloring pattern acquired in S2707, the coloring patterns are narrowed down to coloring patterns in which the sum of the four color differences ΔE is 3.0 or less. Next, the coloring pattern selection unit 215 selects, by the same method as in S908, a coloring pattern matching the target impression from the coloring patterns that are narrowed down above. Note that in this example, the sum of the color differences of colors included in each coloring pattern is used to calculate the distance between the coloring patterns. However, for example, only the color difference of color 1 shown in FIG. 11A may be used. This can make variations of coloring patterns while maintaining the similarity of design by matching colors as the base of the design.

In S2710, the font selection unit 216 selects a combination of fonts matching the target impression and the brand information acquired in S2707. First, the font selection unit 216 narrows down all fonts to only fonts of the same font family as the font acquired in S2707. The font family indicates a type of fonts, and fonts of the same font family have the same design and difference thicknesses. Next, the font selection unit 216 selects, by the same method as in S909, a combination of fonts matching the target impression from the fonts that are narrowed down.

In S2711, the image correction parameter selection unit 221 selects an image correction parameter matching the target impression and the brand information acquired in S2707. Image correction in this example includes gamma correction of brightness and chroma, color temperature correction, and edge amount correction.

FIG. 27B shows a sub-flow so as to explain S2711 in detail.

In S2721, the image correction parameter selection unit 221 extracts the principal color (reference principal color) of the image data acquired in S2707. Note that the principal color is extracted by the same method as in S941 in FIG. 9D.

In S2722, the image correction parameter selection unit 221 extracts the principal color (adjustment principal color) of image data to be arranged on the commercial material. Note that here, since the image data is not arranged on the skeleton yet, the principal color in the whole image data is extracted.

In S2723, the image correction parameter selection unit 221 narrows down the range of the image correction parameter based on the reference principal color extracted in S2721 and the adjustment principal color extracted in S2722. Here, a case where the reference principal color is RGB (220, 110, 200), and the adjustment principal color is RGB (140, 0, 140) will be described as an example. In this example, according to RGB-HSL conversion, the luminance value L of the reference principal color is 62, and the luminance value L of the adjustment principal color is 37. For this reason, for example, in gamma correction of brightness, the range is narrowed down such that gamma correction is performed to make the luminance value of the adjustment principal color close to the luminance value of the reference principal color. Since the calculation expression of gamma correction is as follows, correction of y≈0.73 is needed to make the luminance value of the adjustment principal color to the luminance value of the reference principal color.

$${L}^{′} = 255 \times ( L \div 255 ) \hat{} γ$$

L′: luminance value of reference principal color, L: luminance value of adjustment principal color

In this example, to obtain a luminance value near the reference principal color, a range of +0.1 is set to that of the image correction parameter. That is, here, the range of the correction parameter of the luminance value is 0.63<γ<0.83. Note that to prevent image quality from deteriorating due to extreme correction, an upper limit value and a lower limit value may be provided for the range. In gamma correction of chroma, the above-described luminance value is replaced with chroma, and the same processing is performed, thereby narrowing down the range. In color temperature correction, a color temperature at which the color difference ΔE between the adjustment principal color and the reference principal color is minimized in accordance with the RGB magnification shown in FIG. 31 is obtained, and a range of +1000 K of the color temperature is set to the range.

In S2724, the image correction parameter selection unit 221 selects an image correction parameter matching the target impression, as in S910, within the range of the image correction parameter narrowed down in S2723.

S2711 has been described above. As described above, each image correction parameter is limited such that an image close to the image of the first commercial material is obtained, but some margin is provided for the image correction parameter. It is therefore possible to select, in a later step, a commercial material based on the image similarity, the design similarity, and the impression matching level in the final design. The explanation will return to FIG. 27A.

After S916, in S2712, the multiple commercial material selection unit 220 selects one commercial material from the plurality of (five, in this example) commercial materials created for one commercial material type based on the estimated impression acquired from the impression estimation unit 218, the design similarity acquired by the design similarity calculation unit 219, and the image similarity acquired by the image similarity calculation unit 222. More specifically, first, the multiple commercial material selection unit 220 calculates the impression distance between the estimated impression linked with the commercial material data and the target impression, as in S917. Next, as in S915, the design similarity between the first commercial material and the created commercial material is calculated. Next, as in S916, the image similarity between the first commercial material and the created commercial material is calculated. Finally, a commercial material for which the sum of the impression distance, the design similarity, and the image similarity is minimum is selected. The selected commercial material is stored in the RAM 103. The selected commercial material is displayed on the preview screen 601 in S918.

Hence, even if the user does not know about an impression or a brand, it is possible to automatically set an impression and brand information by selecting the generation result of a commercial material. As a result, it is possible to automatically generate designs that give a sense of unity and give the impression of a brand intended by a user without performing a cumbersome repeating operation.

### Second Embodiment

The second embodiment will be described below concerning differences from the first embodiment. In the first embodiment, an example in which a skeleton, a coloring pattern, and a font that are the constituent elements of a commercial material are selected based on a target impression, a commercial material set formed by commercial materials of different types is generated, and the design similarity and the image similarity between the commercial materials are calculated, thereby generating a design in which the similarity level of design elements is high between different commercial materials has been described. In the second embodiment, a combination generation unit 1702 searches for a combination of constituent elements of a commercial material, which makes the impression of the whole poster close to the target impression and a combination of design elements in which the degree of design similarity is high based on a genetic algorithm. This makes it possible to more flexibly select constituent elements of a commercial material, which are optimum for the target impression, and constituent elements having a high degree of design similarity without creating a skeleton impression table, a coloring pattern impression table, a font impression table, and an image correction parameter table in advance.

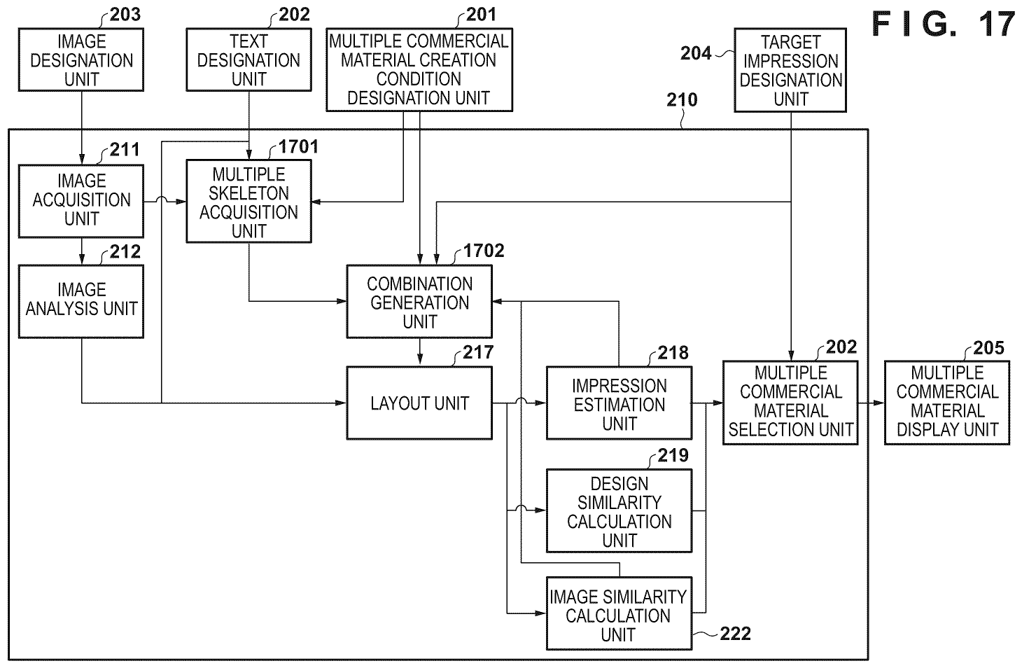

FIG. 17 is a software block diagram of a multiple commercial material creation application according to the second embodiment. In the configuration of the block diagram shown in FIG. 17, a multiple skeleton acquisition unit 1701 and the combination generation unit 1702 are formed in place of the skeleton selection unit 214, the coloring pattern selection unit 215, the font selection unit 216, and the image correction parameter selection unit 221 in FIG. 2. Note that the components denoted by the same reference numerals as in FIG. 2 execute the same processes as those described in the first embodiment, and a description thereof will be omitted here.

The multiple skeleton acquisition unit 1701 acquires skeletons for commercial material types designated by a multiple commercial material creation condition designation unit 201. To use the genetic algorithm, all skeletons for designated commercial material types are acquired and stored in a RAM 103.

The combination generation unit 1702 acquires one or a plurality of skeletons for the commercial material types from the multiple skeleton acquisition unit 1701 and acquires commercial material data and a commercial material estimated impression from an impression estimation unit 218. The combination generation unit 1702 acquires a target impression from a target impression designation unit 204, acquires a design similarity between commercial materials from a design similarity calculation unit 219, and acquires an image similarity between commercial materials from an image similarity calculation unit 222. Furthermore, the combination generation unit 1702 acquires lists of coloring patterns and fonts and a pattern list from an HDD 104. Also, the combination generation unit 1702 generates combinations of constituent elements (skeletons, coloring patterns, fonts, and image correction parameters) and design elements (logos and patterns) of commercial materials used for commercial material generation for the commercial material types. As an example, in this embodiment, a combination of three commercial material types, that is, a poster, a postcard, and a banner is generated. One combination of the commercial material types is defined as one commercial material set combination. The combination generation unit 1702 outputs the generated commercial material set combinations to the layout unit 217.

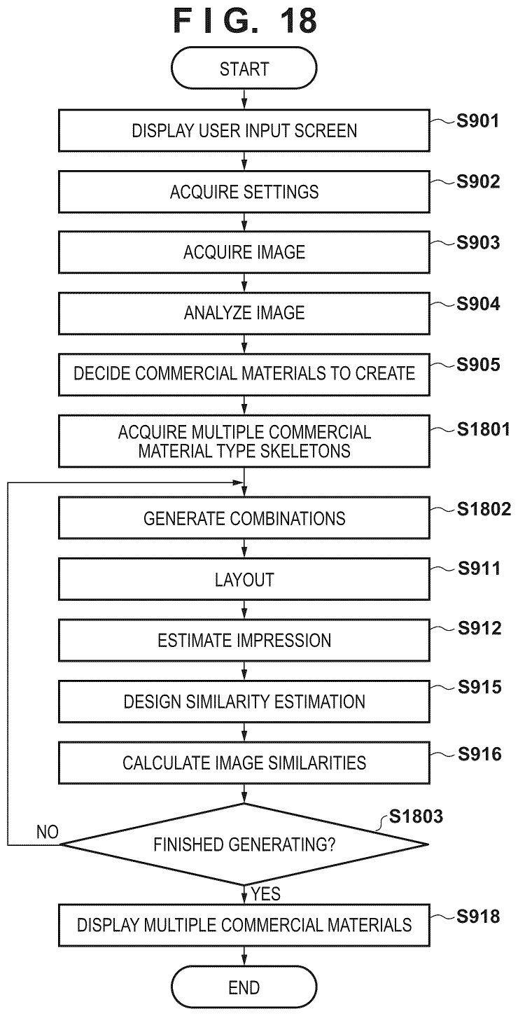

FIG. 18 is a flowchart showing processing of a multiple commercial material generation unit 210 of the multiple commercial material creation application according to this embodiment. Note that in the processing of this flowchart, processes indicated by the same numbers as in the flowchart of FIG. 9 execute the same processes described in the first embodiment, and a description thereof will be omitted here. Note that in the processing of this flowchart, S906 to S910 and S913 shown in FIG. 9 are omitted.

After S905, in S1801, the multiple skeleton acquisition unit 1701 acquires skeletons for commercial material types designated by the multiple commercial material creation condition designation unit 201. More specifically, the processes of S921 to S926 in FIG. 9B are repeated as many times as the number of designated commercial material types. To use the genetic algorithm, all skeletons for the designated commercial material types are acquired. As an example, in FIG. 5, all skeletons for a poster, a postcard, and a banner are acquired.

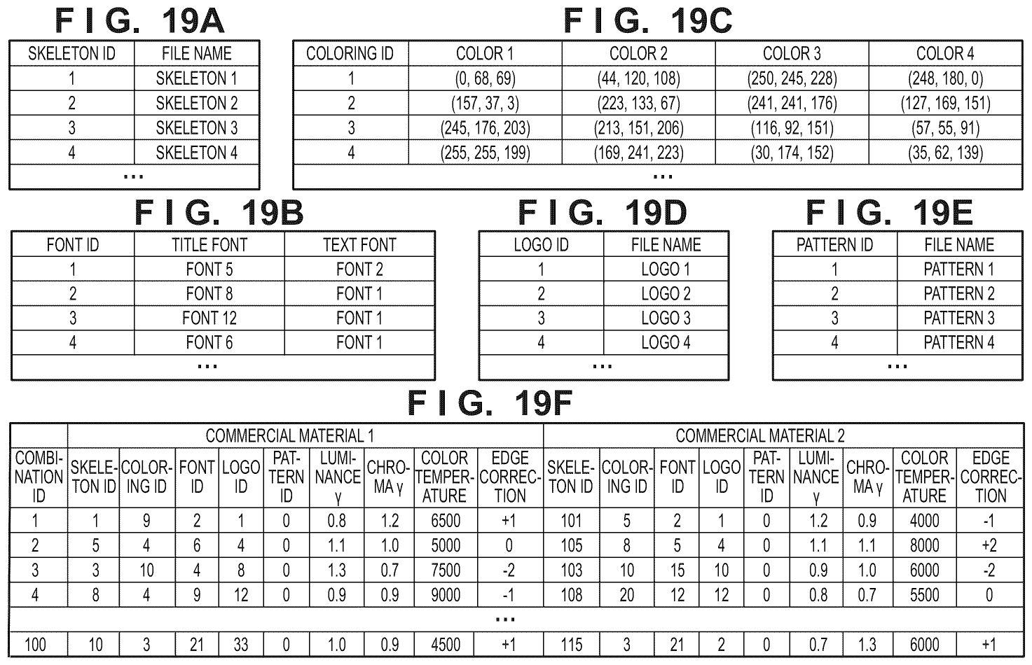

In the description of S1802, an operation at the time of execution for the first time and an operation from the second loop will separately be described. When executing S1802 for the first time, the combination generation unit 1702 acquires the tables of skeletons, colorings, fonts, logos, and patterns to be used for commercial material generation. FIGS. 19A to 19F are views for explaining the tables used by the combination generation unit 1702. FIG. 19A shows a list of skeletons that the combination generation unit 1702 acquires from the multiple skeleton acquisition unit 1701. FIGS. 19B, 19C, 19D, and 19E show a list of fonts, a list of colorings, a list of logos, and a list of patterns, respectively, that the combination generation unit 1702 acquires from the HDD 104. The combination generation unit 1702 generates the designated commercial materials for the commercial material types in random combinations from the five tables. In this example, 100 commercial material set combinations are generated. Image correction parameters are also combined at random. In this embodiment, random values are combined within the range of 0.7 to 1.3 for y in luminance gamma correction and chroma gamma correction, within the range of 4,000 K to 9,000 K of for the color temperature, and within the range of −2 to +2 for the edge correction amount.

FIG. 19F shows an example of a commercial material set combination table generated in this embodiment. Note that edge correction in FIG. 19F indicates how to apply edge correction and a degree thereof, and “+” indicates a sharpening filter, and “−” indicates a blur filter. Also, “+1” and “+2” indicate that the addition coefficients of a Laplacian filter are 0.5 and 1, respectively, “−1” and “−2” indicate that the σ values of a Gaussian filter are 1.5 and 2, respectively, and “O” indicates that edge correction is not performed. If brand information is designated by the multiple commercial material creation condition designation unit 201, setting is done such that the same ID is set for the commercial materials. FIG. 19F shows a combination table in a case where a pattern is designated as brand information. The same pattern ID is set for commercial material 1 and commercial material 2. Also, if the reflection level of brand information is designated by the multiple commercial material creation condition designation unit 201, the ratio of the same ID between commercial material 1 and commercial material 2 is decided based on the setting value. More specifically, for example, if the reflection level of brand information is designated to 0.3, 30 combinations among the 100 combinations have the same ID, and remaining 70 combinations are random combinations. After that, the combination generation unit 1702 executes for all the generated combinations, the processes of S911 (layout), S912 (impression estimation), S915 (design similarity estimation), and S1803.

Next, from the second loop of S1802, the combination generation unit 1702 calculates an evaluation value from the estimated impression acquired from the impression estimation unit 218, the design similarity acquired from the design similarity calculation unit 219, and the image similarity acquired from the image similarity calculation unit 222 and links it with the commercial material set combination table. The evaluation value calculation method is the same as the method of calculating the sum of the total impression distance, the design similarity, and the image similarity in S917 of FIG. 9.

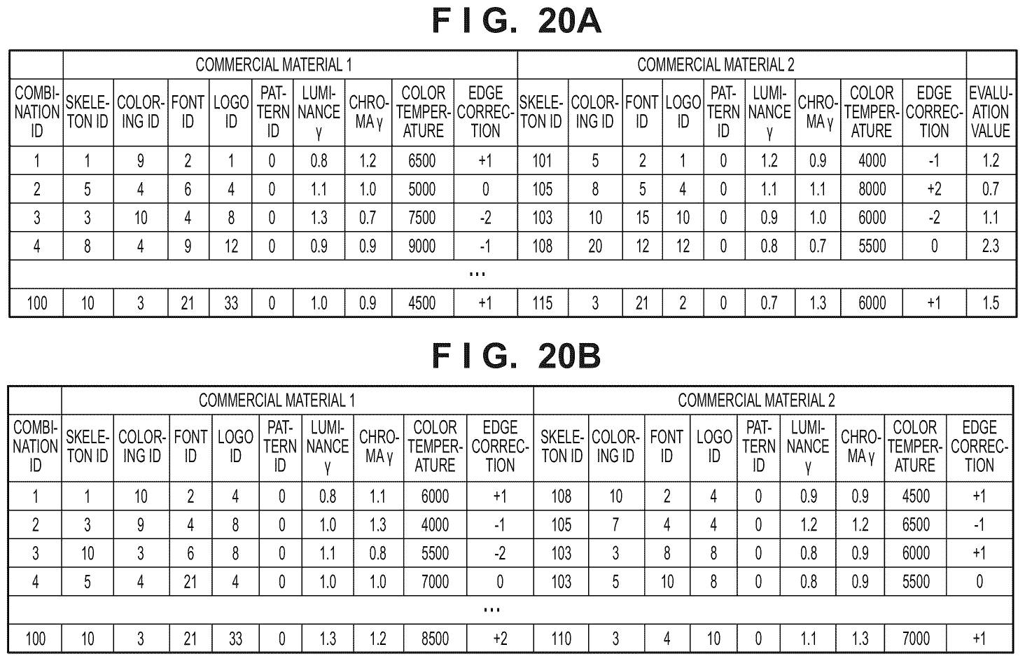

FIGS. 20A and 20B are views for explaining the operation of S1802 from the second loop. FIG. 20A is a table that links the above-described evaluation value with FIG. 19D. The evaluation value column in FIG. 20A indicates the evaluation values of commercial material sets generated in the combinations of the rows. The combination generation unit 1702 generates a new combination table from FIG. 20A. FIG. 20B shows the newly generated combination table. In this embodiment, new combinations are generated using tournament selection and uniform crossover in a genetic algorithm. First, N combinations are selected at random from the table shown in FIG. 20A. Here, for example, N=3. Next, two high-rank combinations each having a small evaluation value are selected from the selected combinations. Finally, in the two selected combinations, the elements (skeleton IDs, coloring pattern IDs, font IDs, logo IDs, pattern IDs, and image correction parameters) of the combinations are replaced with each other at random, thereby generating new combinations. For example, combination IDs 1 and 2 in FIG. 20B show the results generated from combination IDs 1 and 3 in FIG. 20A, and the coloring pattern IDs are replaced here. FIG. 20B shows the result of generating 100 new combinations by repeating the above-described procedure.

This makes it possible to efficiently search for a combination based on the evaluation value of the total impression distance, the design similarity, and the image similarity. Note that in this embodiment, 100 combinations are generated, but the present invention is not limited to this. Also, tournament selection and uniform crossover are used. However, the present invention is not limited to this and, for example, another method such as ranking selection, roulette selection, or single point crossover may be used. In addition, mutation may be incorporated such that a risk of falling into a local optimal resolution is eliminated. A skeleton (arrangement), a coloring pattern, a font, a logo, and a pattern are used as the constituent elements of the commercial material to be searched for. However, other constituent elements may be used. When the constituent elements to be searched for are increased, more variations of posters can be generated, and the width of impression expression can be increased.

In S1803, a multiple commercial material selection unit 1703 calculates the evaluation value of the total impression distance and the design similarity, like S1802, and creates the same table as in FIG. 20A. The multiple commercial material selection unit 1703 stores, in the RAM 103, commercial material sets for which the evaluation value of the total impression distance, the design similarity, and the image similarity is equal to or less than a threshold.

In S1803, additionally, the multiple commercial material selection unit 1703 determines whether the number of commercial material sets stored in the RAM 103 has reached a predetermined number of combinations. Upon determining that the number of commercial material sets has reached the predetermined number of combinations, the multiple commercial material selection unit 1703 advances to S918. Upon determining that the number of commercial material sets has not reached the predetermined number of combinations, the multiple commercial material selection unit 1703 returns to S1802. That is, the above-described process of S1802 in the second loop is executed, and the processes of S1802 to S1803 are repetitively executed until the number of commercial material sets stored in the RAM 103, for which the evaluation value of the total impression distance, the design similarity, and the image similarity is equal to or less than the threshold, reaches the predetermined number. Note that if the number of stored commercial material sets for which the evaluation value is equal to or less than the threshold is equal to or more than the predetermined number, the multiple commercial material selection unit 1703 may compare the evaluation values of the stored commercial material sets, and finally store only the commercial material sets having a smaller evaluation value in the RAM 103. A commercial material set judged to have a larger evaluation value based on the comparison result may be deleted from the RAM 103.

Note that in this embodiment, a combination of constituent elements and design elements used in a commercial material is searched for by the genetic algorithm. However, the search method is not limited to this, and another search method such as neighborhood search or tab search may be used.

As described above, according to this embodiment, a combination of constituent elements and design elements used in a commercial material is searched for, thereby generating a commercial material set for which the impression is close to the target impression, and the design gives a sense of unity in the plurality of commercial materials. This is particularly effective when generating a commercial material set in accordance with an image or character information input by the user. For example, consider a case where although an image has a dynamic impression, a commercial material set with a restrained impression should be generated as a whole. In this embodiment, it is possible to evaluate the impression of the whole commercial material and search for a combination of a skeleton, a coloring pattern, a font, a logo, a pattern, and an image correction parameter in which the impression is close to the target impression, and the design similarity and the image similarity are high. Hence, to suppress the impression of an image, the constituent elements of the commercial material can be controlled in accordance with the image by, for example, using a skeleton with a small image area, using more restrained fonts and colors, or suppressing chroma by the image correction parameter. Furthermore, even if the impression intended by the user and the impression held by brand information are different, a skeleton in which the area to arrange the brand information is small can be used. According to this embodiment, it is possible to flexibly find a combination of constituent elements optimum for the impression of an entire commercial material set and design elements giving a sense of unity and create various variations of commercial material sets giving a sense of unity and giving the impression of a brand intended by the user.

### Third Embodiment

In the first and second embodiments, an example in which a commercial material is generated based on setting values set in the activation screen 501 has been described. In the third embodiment, an example in which a new commercial material is generated based on stored commercial material data will be described. It is not finished once commercial materials are created, and commercial materials are repetitively created for seasonal events or festivities. In this case, to make people further recognize a brand, it is necessary to repetitively reflect the same design or impression on commercial materials and create these, instead of using a different design each time. In this embodiment, impression information and brand information of a previously created commercial material are reflected on an activation screen, thereby generating a commercial material giving the impression of a brand intended by the user even after the elapse of time.

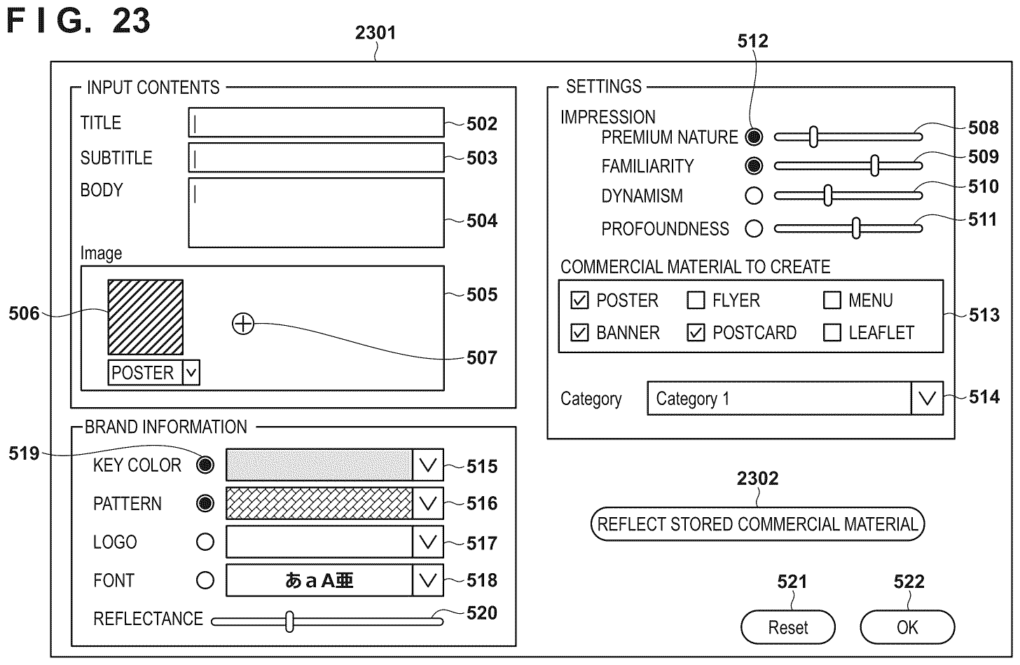

FIG. 23 is a view showing an example of an application activation screen 2301 provided by a multiple commercial material creation application according to the third embodiment. The application activation screen 2301 is displayed in the process of S901 shown in FIG. 9. The components denoted by the same reference numerals as in FIG. 5 perform the same processes described in the first embodiment, and a description thereof will be omitted here.

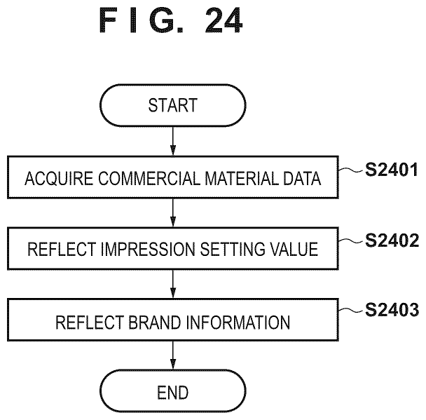

A “reflect stored commercial material” button 2302 can reflect commercial material data stored by a storage button 605 on a preview screen 601 shown in FIG. 6 on settings in the application activation screen 2301. FIG. 24 is a flowchart when the “reflect stored commercial material” button 2302 is pressed.

In S2401, the multiple commercial material creation application displays a UI (not shown) that allows the user to select previously stored commercial material data and accepts user selection of commercial material data to be reflected. The selected commercial material data is stored in a RAM 103.

In S2402, the multiple commercial material creation application acquires an impression setting value from the selected commercial material data and reflects it on the settings in the application activation screen 2301. More specifically, for example, a target impression is acquired from the selected commercial material data and reflected on impression sliders 508 to 511 and an impression enable radio button 512 in the application activation screen 2301. At the time of reflection, if an impression enable setting is absent in the application activation screen 2301, an impression having a large absolute value of impression is enabled, and an impression having a small absolute value of impression is disabled. This is because an impression having a large absolute value of impression can be estimated as an impression representing a brand. More specifically, for example, if the absolute value of an impression is larger than 1, the impression is enabled. Alternatively, impressions may be compared, and two high-rank impressions with large absolute values of impression may be enabled. This makes it possible to repetitively set the impression value of the same impression without particular consciousness of the user.

In S2403, the multiple commercial material creation application acquires brand information from the selected commercial material data and reflects it on the settings in the application activation screen 2301. More specifically, for example, brand information is acquired from the selected commercial material data and reflected on a key color designation box 515, a pattern designation box 516, a logo designating box 517, a font designation box 518, and a reflection level slider bar 520 in the application activation screen 2301. This makes it possible to repetitively set the impression value of the same design element without particular consciousness of the user.

After the impression information and the brand information of the selected commercial material are reflected, the user inputs content and selects a commercial material and a category, thereby generating a plurality of commercial materials. The method of generating the plurality of commercial materials is the same as in the first and second embodiments.

It is therefore possible to repetitively generate a commercial material having the same impression and the same design elements without particular consciousness of the user. Also, by inputting contents to be arranged, commercial materials optimum for all the input contents and the impression and brand information of the previously created commercial material can be generated.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-163581, filed Sep. 26, 2023, which is hereby incorporated by reference herein in its entirety.

What is claimed is:

1. An information processing apparatus comprising:
at least one processor and at least a memory coupled to the at least one processor and having instructions stored thereon, and when executed by the at least one processor, acting as:
a first acceptance unit configured to accept content of a commercial material;
a second acceptance unit configured to accept a brand design;
a third acceptance unit configured to accept a designation of an impression that the commercial material gives to a user;
a fourth acceptance unit configured to accept a condition of the commercial material;
a first generation unit configured to generate a plurality of commercial material data corresponding to a first commercial material type based on the content accepted by the first acceptance unit, the brand design accepted by the second acceptance unit, the designation of the impression accepted by the third acceptance unit, and the condition of the commercial material accepted by the fourth acceptance unit;
a second generation unit configured to generate a plurality of commercial material data corresponding to a second commercial material type based on the content accepted by the first acceptance unit, the brand design accepted by the second acceptance unit, the designation of the impression accepted by the third acceptance unit, and the condition of the commercial material accepted by the fourth acceptance unit; and
a display unit configured to display a commercial material image based on first commercial material data included in the plurality of commercial material data generated by the first generation unit and second commercial material data included in the plurality of commercial material data generated by the second generation unit,
wherein the first commercial material data and the second commercial material data displayed by the display unit are commercial material data of a combination in which a similarity of content is highest, and a similarity of the brand design is highest among a plurality of combinations obtained from the plurality of commercial material data generated by the first generation unit and the plurality of commercial material data generated by the second generation unit.

2. The apparatus according to claim 1, wherein the at least one processor and the at least a memory further act as:
a first acquisition unit configured to acquire the similarity of the content for each of the plurality of combinations.

3. The apparatus according to claim 2, wherein as the similarity of the content, the first acquisition unit acquires a similarity between a color included in an image as content of the first commercial material data and a color included in an image as content of the second commercial material data.

4. The apparatus according to claim 2, wherein the at least one processor and the at least a memory further act as:
a second acquisition unit configured to acquire a similarity of the brand design for each of the plurality of combinations.

5. The apparatus according to claim 4, wherein as the similarity of the brand design, the second acquisition unit acquires a similarity between a coloring represented by the first commercial material data and a coloring represented by the second commercial material data.

6. The apparatus according to claim 4, wherein as the similarity of the brand design, the second acquisition unit acquires a similarity between a pattern of a background represented by the first commercial material data and a pattern of a background represented by the second commercial material data.

7. The apparatus according to claim 4, wherein as the similarity of the brand design, the second acquisition unit acquires a similarity between a logo represented by the first commercial material data and a logo represented by the second commercial material data.

8. The apparatus according to claim 4, wherein as the similarity of the brand design, the second acquisition unit acquires a similarity between a font designated by a text as the content of the first commercial material data and a font designated by a text as the content of the second commercial material data.

9. The apparatus according to claim 4, wherein the at least one processor and the at least a memory further act as:
a selection unit configured to select a combination to be displayed by the display unit based on the similarity of the content acquired by the first acquisition unit and the similarity of the brand design acquired by the second acquisition unit, and
the display unit displays the first commercial material data and the second commercial material data of the combination selected by the selection unit.

10. The apparatus according to claim 9, wherein the at least one processor and the at least a memory further act as:
a first estimation unit configured to estimate an impression of each of the plurality of commercial material data generated by the first generation unit;
a second estimation unit configured to estimate an impression of each of the plurality of commercial material data generated by the second generation unit, and
the selection unit selects the combination to be displayed by the display unit based on the impression estimated for each of the plurality of commercial material data generated by the first generation unit and the impression estimated for each of the plurality of commercial material data generated by the second generation unit.

11. The apparatus according to claim 10, wherein the at least one processor and the at least a memory further act as:
a fifth acceptance unit configured to accept a reflection level of the brand design on the display by the display unit, and
the selection unit selects the combination to be displayed by the display unit based on the reflection level accepted by the fifth acceptance unit.

12. The apparatus according to claim 1, wherein the at least one processor and the at least a memory further act as:
a second acquisition unit configured to acquire a plurality of commercial material constituent elements corresponding to the first commercial material type based on the designation of the impression accepted by the third acceptance unit; and
a third acquisition unit configured to acquire a plurality of commercial material constituent elements corresponding to the second commercial material type based on the designation of the impression accepted by the third acceptance unit,
the first generation unit generates the plurality of commercial material data corresponding to the plurality of commercial material constituent elements acquired by the second acquisition unit, and
the second generation unit generates the plurality of commercial material data corresponding to the plurality of commercial material constituent elements acquired by the third acquisition unit.

13. The apparatus according to claim 12, wherein the at least one processor and the at least a memory further act as:
a storage unit configured to store a table in which the plurality of commercial material constituent elements are determined, and
in the table, each of the plurality of commercial material constituent elements is associated with an impression.

14. The apparatus according to claim 13, wherein
the second acquisition unit acquires, from the table, a plurality of commercial material constituent elements close to the designation of the impression accepted by the third acceptance unit, and
the third acquisition unit acquires, from the table, a plurality of commercial material constituent elements close to the designation of the impression accepted by the third acceptance unit.

15. The apparatus according to claim 12, wherein acquisition of the plurality of commercial material constituent elements corresponding to the first commercial material type by the second acquisition unit and acquisition of the plurality of commercial material constituent elements corresponding to the second commercial material type by the third acquisition unit are performed by a genetic algorithm.

16. The apparatus according to claim 12, wherein the commercial material constituent element includes a skeleton configured to decide an arrangement of the content.

17. The apparatus according to claim 12, wherein the commercial material constituent element includes a coloring pattern.

18. The apparatus according to claim 17, wherein the coloring pattern is a combination of a plurality of colors.

19. The apparatus according to claim 12, wherein the commercial material constituent element includes a font pattern.

20. The apparatus according to claim 19, wherein the font pattern is a combination of a title font and a text font.

21. The apparatus according to claim 12, wherein the commercial material constituent element includes a parameter used for image correction, and
the image correction is performed in generation of the plurality of commercial material data corresponding to the first commercial material type by the first generation unit and generation of the plurality of commercial material data corresponding to the second commercial material type by the second generation unit.

22. The apparatus according to claim 21, wherein the image correction includes at least one of correction of a brightness or a chroma, correction of a hue, and correction of an edge amount.

23. The apparatus according to claim 1, wherein a first commercial material image represented by the first commercial material data and a second commercial material image represented by the second commercial material data are displayed such that the user can perform selection.

24. The apparatus according to claim 23, wherein the at least one processor and the at least a memory further act as:
a saving unit configured to save commercial material data of a commercial material image selected by the user from the first commercial material image and the second commercial material image together with information about an impression of the selected commercial material data and information about the brand design.

25. The apparatus according to claim 24, wherein the at least one processor and the at least a memory further act as:
a second display unit configured to display a setting screen including the first acceptance unit, the second acceptance unit, the third acceptance unit, and the fourth acceptance unit based on the information saved by the saving unit.

26. The apparatus according to claim 1, wherein the condition of the commercial material includes a type of the commercial material.

27. The apparatus according to claim 1, wherein the commercial material includes at least one of a poster, a banner, and a postcard.

28. A method executed in an information processing apparatus, comprising:
accepting content of a commercial material;
accepting a brand design;
accepting a designation of an impression that the commercial material gives to a user;
accepting a condition of the commercial material;
generating a plurality of commercial material data corresponding to a first commercial material type based on the accepted content, the accepted brand design, the accepted designation of the impression, and the accepted condition of the commercial material;
generating a plurality of commercial material data corresponding to a second commercial material type based on the accepted content, the accepted brand design, the accepted designation of the impression, and the accepted condition of the commercial material; and
displaying a commercial material image based on first commercial material data included in the plurality of generated commercial material data and second commercial material data included in the plurality of generated commercial material data,
wherein the first commercial material data and the second commercial material data to be displayed are commercial material data of a combination in which a similarity of content is highest, and a similarity of the brand design is highest among a plurality of combinations obtained from the plurality of generated commercial material data and the plurality of generated commercial material data.

29. A non-transitory computer-readable storage medium that stores one or more programs including instructions, which when executed by one or more processors of an information processing apparatus, cause the information processing apparatus to perform a method, the method comprising:
accepting content of a commercial material;
accepting a brand design;
accepting a designation of an impression that the commercial material gives to a user;
accepting a condition of the commercial material;
generating a plurality of commercial material data corresponding to a first commercial material type based on the accepted content, the accepted brand design, the accepted designation of the impression, and the accepted condition of the commercial material;
generating a plurality of commercial material data corresponding to a second commercial material type based on the accepted content, the accepted brand design, the accepted designation of the impression, and the accepted condition of the commercial material; and
displaying a commercial material image based on first commercial material data included in the plurality of generated commercial material data and second commercial material data included in the plurality of generated commercial material data,
wherein the first commercial material data and the second commercial material data to be displayed are commercial material data of a combination in which a similarity of content is highest, and a similarity of the brand design is highest among a plurality of combinations obtained from the plurality of generated commercial material data and the plurality of generated commercial material data.
